(19) United States
(12) Patent Application Publication
(10) Pub. No.: US 2006/0206580 A1
(43) Pub. Date: Sep. 14, 2006

(54) MULTIMEDIA DISTRIBUTION APPARATUS AND METHOD

(76) Inventor: Oliver W. Johnson III., Okolona, MS (US)

Correspondence Address: ADAMS EVANS P.A., 2180 TWO WACHOVIA CENTER, CHARLOTTE, NC, 28282, US

(21) Appl. No.: 11/308,144

(22) Filed: Mar. 8, 2006

Related U.S. Application Data
(60) Provisional application No. 60/659,739, filed on Mar. 8, 2005.

(51) Int. Cl. G06F 15/16; H04N 5/44

(52) U.S. Cl. 709/217; 715/716

(57) ABSTRACT

A multimedia apparatus for allowing an individual to upload and download multimedia content to and from a central command center. The multimedia apparatus includes an enclosure for providing a quiet environment and a communication means for uploading edited audio and video content to the central command center. The enclosure includes an audio recording means for recording audio content, a video recording means for recording video content, an editing means for editing the recorded audio and video content, and a storage means for storing edited audio and video content locally.

This application claims the benefit of Provisional Application No. 60/659,739 filed on Mar. 8, 2005.

### TECHNICAL FIELD AND BACKGROUND OF THE INVENTION

This invention relates to a method and apparatus for distributing audio, video, or various other materials to consumers and more specifically to a method and remote apparatus that allows consumers to spontaneously record and upload a performance, upload a previously recorded performance, or preview and download materials.

Multimedia distribution systems of varying types are well-known in the art. Many distribution systems allow a consumer to download materials from the internet using their personal computer, while others allow consumers to access downloadable materials at a remote site. For example, U.S. Pat. No. 6,385,596 to Wiser et al. discloses a secure online music distribution system that allows a consumer to select, preview, and download audio and other digital material over the internet. The system uses a delivery server to deliver the material to the consumer via a media player, thereby allowing a consumer to burn the material onto their hard drive or onto a CD-R or other external device.

Typically, the internet media distribution model requires a customer to go to an internet site, select or be given a media selection, download reception software and a key, preview or purchase a selection, download a one-to-one encrypted compressed copy of the selection, decrypt the selection with software and play or save the selection on the consumer's computer or write it to a CD, DVD, MD or digital player. The download is then stored in some form on the customer's hard drive.

U.S. Publication No. 2003/0078986 to Ayers et al. discloses a distributed multimedia transfer system that uses a network of multimedia distribution kiosks for downloading and uploading multimedia data. The network may be stand-alone or internet based. The kiosks allow consumers to download material and burn it onto a CD or other format and upload pre-recorded material to a content server for distribution.

U.S. Pat. No. 5,734719 to Tsevdos et al. discloses a digital information accessing delivery and production system which includes a preview station, such as a kiosk, located in a store. The customer accesses the preview station and selects material to purchase. The preview station prints out the order and the customer proceeds to the sales clerk for payment. A manufacturing machine then records the selected material onto a storage device which is then distributed to the customer.

While these distribution systems are capable of distributing materials to a customer, they do not allow a customer to spontaneously perform and distribute their own material.

### SUMMARY OF THE INVENTION

Therefore, it is an object of the invention to provide a method for allowing a consumer to spontaneously record material and upload the material for distribution.

It is another object of the invention to allow multiple consumers located at various locations to perform and record material for distribution.

It is another object of the invention to provide a method for allowing a consumer to download material without an internet connection.

It is another object of the invention to provide a method for distributing material to a broad base of consumers.

It is another object of the invention to provide an apparatus that provides a mini-studio environment, allowing consumers to produce their own material.

It is another object of the invention to provide an apparatus that allows a consumer to record material and upload the material for distribution.

It is another object of the invention to provide an apparatus that allows a consumer to edit recorded materials.

These and other objects of the present invention are achieved in the preferred embodiments disclosed below by providing a multimedia apparatus for allowing an individual to upload and download multimedia content to and from a central command center, including an enclosure for providing a quiet environment and a communication means for uploading edited audio and video content to the central command center. The enclosure including an audio recording means for recording audio content, a video recording means for recording video content, an editing means for editing the recorded audio and video content, and a storage means for storing edited audio and video content locally.

According to another preferred embodiment of the invention, the audio recording means includes a microphone selected from the group consisting of a large diaphragm condenser microphone and a small diaphragm condenser microphone.

According to another preferred embodiment of the invention, the multimedia apparatus further include a means for performing karaoke.

According to another preferred embodiment of the invention, the means for performing karaoke includes a touchscreen with lyrics displayed thereon.

According to another preferred embodiment of the invention, the means for performing karaoke further includes a green screen for selecting a background.

According to another preferred embodiment of the invention, the communication means is selected from the group consisting of hard-wired transmission systems and wireless transmission systems.

According to another preferred embodiment of the invention, further including a touch screen and graphical user interface for inputting commands to the multimedia apparatus and allowing an individual to browse and search a catalogue of recorded content to sample, select, download, burn, and purchase the recorded content using direct point of sale communications.

According to another preferred embodiment of the invention, the enclosure further includes a monitor for video playback of the video content and at least one speaker for audio playback of the audio content.

According to another preferred embodiment of the invention, the enclosure further includes at least one media reader for uploading previously recorded content to the multimedia apparatus.

According to another preferred embodiment of the invention, the enclosure further includes at least one writing device for downloading and writing the audio and video content to digital media.

According to another preferred embodiment of the invention, a multimedia distribution network including a central command center for receiving, storing, and distributing audio and video content, at least one multimedia apparatus remote from the central command center for allowing an individual to upload and download audio and video content to and from the central command center, and a communications system interconnecting the at least one multimedia apparatus and the central command center, so as to allow the multimedia apparatus to upload audio and video content to the central command center and download audio and video content from the central command center. The at least one multimedia apparatus including an enclosure for providing a quiet environment, the enclosure including means for recording audio and video content, an editing means for editing the audio and video content, and a storage means for storing the audio and video content locally.

According to another preferred embodiment of the invention, wherein the means for recording audio content includes a microphone selected from the group consisting of a large diaphragm condenser microphone and a small diaphragm condenser microphone.

According to another preferred embodiment of the invention, the means for recording video content includes a video camera.

According to another preferred embodiment of the invention, the editing means is selected from the group consisting of multi-track wave editors, sequencers, and mixers.

According to another preferred embodiment of the invention, the storage means includes a computer.

According to another preferred embodiment of the invention, the central command center includes network and communication services, such as a server, a router, and a switch for blanket transmitting the audio and video content to the at least one multimedia apparatus, personal computers, cellular phones, and kiosks.

According to another preferred embodiment of the invention, the audio and video content include music, poetry, comedy, independent films, audio books, ringtones, and wallpaper.

According to another preferred embodiment of the invention, the communications system includes networks selected from the group consisting of high-speed telephony, fiber-optic, cable, internet protocol, internet, intranet, multicast, and peer to peer.

According to another preferred embodiment of the invention, the communications system includes a first network interface and a second network interface interconnected by a shared non-switched system bus for allowing the communications system to interface with multiple networks and protocols.

According to another preferred embodiment of the invention, a method for uploading and distributing recorded content, including the steps of providing a multimedia apparatus including an enclosure and a communication means, the enclosure including an uploading means, an editing means, and a storage device; uploading and saving the recorded content to the multimedia apparatus using the uploading means; editing the recorded content using the editing means; saving an edited version of the recorded content to the storage device; and uploading the edited version through the communication means to a command center for distribution.

According to another preferred embodiment of the invention, the uploading means is a media reader for allowing previously recorded content to be uploaded to the multimedia apparatus.

According to another preferred embodiment of the invention, the step of uploading and saving the recorded content includes the step of placing previously recorded content into the media reader and saving the recorded content to the storage device.

According to another preferred embodiment of the invention, the uploading means is a microphone for allowing spontaneously performed recorded content to be uploaded to the multimedia apparatus.

According to another preferred embodiment of the invention, the step of uploading and saving the recorded content includes the step of activating the microphone so as to allow the recorded content to be saved to the storage device.

According to another preferred embodiment of the invention, the uploading means is a video camera for allowing spontaneously performed recorded content to be uploaded to the multimedia apparatus.

According to another preferred embodiment of the invention, the step of uploading and saving the recorded content includes the step of activating the video camera so as to allow the recorded content to be saved to the storage device.

According to another preferred embodiment of the invention, the editing means is selected from the group consisting of multi-track wave editors, sequencers, and mixers.

According to another preferred embodiment of the invention, the communication means is selected from the group consisting of hard-wired transmission systems and wireless transmission systems.

According to another preferred embodiment of the invention, further including the step of reviewing the edited version.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a schematic of a multimedia distribution network according to an embodiment of the invention;

FIG. 2 is a schematic of a multimedia distribution network of FIG. 1;

FIG. 3 is another schematic of the multimedia distribution network of FIG. 1;

FIG. 4 is another schematic of the multimedia distribution network of FIG. 1;

FIG. 5 shows items that can be used in connection with the multimedia distribution network of FIG. 1;

FIG. 6 shows the possible uses of the multimedia distribution network of FIG. 1;

FIG. 7 is a digital recording on-site interactive downloading device including a studio and a kiosk;

FIG. 8 shows an example layout of the inside of the studio of FIG. 6;

FIG. 9 shows the acoustic reflection inside the studio of FIG. 6;

FIG. 10 shows a user making a recording inside the studio of FIG. 6;

FIG. 11 shows the use of multiple instruments inside the studio of FIG. 6;

FIG. 12 shows a graphical interface used to control the digital recording on-site interactive downloading device of FIG. 6;

FIG. 13 shows another screen of the graphical interface of FIG. 11;

FIG. 14 shows another screen of the graphical interface of FIG. 11;

FIG. 15 shows another screen of the graphical interface of FIG. 11;

FIG. 16 is a flow diagram of the download and upload procedure; FIG. 17 is another flow diagram of the download and upload procedure;

FIG. 18 is another flow diagram of the download and upload procedure;

FIG. 19 is another flow diagram of the download and upload procedure;

FIG. 20 shows the security programs used in the multimedia distribution network of FIG. 1;

FIG. 21 is a flow diagram for creating and distributing a recording;

FIG. 22 is a flow diagram for creating and distributing a ringtone;

FIG. 23 is a flow diagram for creating and distributing a wallpaper;

FIG. 24 shows a karaoke procedure;

FIG. 25 is a flow diagram for a kiosk depicted in FIG. 24;

FIG. 26 is a flow diagram for a website depicted in FIG. 24;

FIG. 27 is a flow diagram for a mobile user depicted in FIG. 24;

FIG. 28 shows individuals having home pages on the distribution network of FIG. 1;

FIG. 29 is a flow diagram of computer multimedia recording/production studios being accessed by multiple devices from various communication systems;

FIG. 30 is a flow diagram of an IP multicast video data download procedure;

FIG. 31 is a flow diagram of an MSDP P2P and multicast traffic procedure;

FIG. 32 is a flow diagram of source and group communications employed by the distribution network of FIG. 1;

FIG. 33 is a flow diagram of network technology employed by the distribution network of FIG. 1 benefiting the efficiency of MSDP P2P and multicast traffic procedures;

FIG. 34 is a flow diagram of dual source and group communications employed by the distribution network of FIG. 1;

FIG. 35 is a flow diagram of packet switching transfers across a carrier network within a wide area network employed by the distribution network of FIG. 1;

FIG. 36 is a schematic of a backbone network employed by the distribution network of FIG. 1 utilizing hubs with segmented hubs and nodes;

FIG. 37 is a schematic of a local area network switch-ring employed by the distribution network of FIG. 1;

FIG. 38 is a schematic of multiple IP addresses being sent across multiple platforms; and

FIG. 39 is a schematic depicting individual PC users and businesses utilizing multiple ISPs to access the global market.

### DESCRIPTION OF THE PREFERRED EMBODIMENT AND BEST MODE

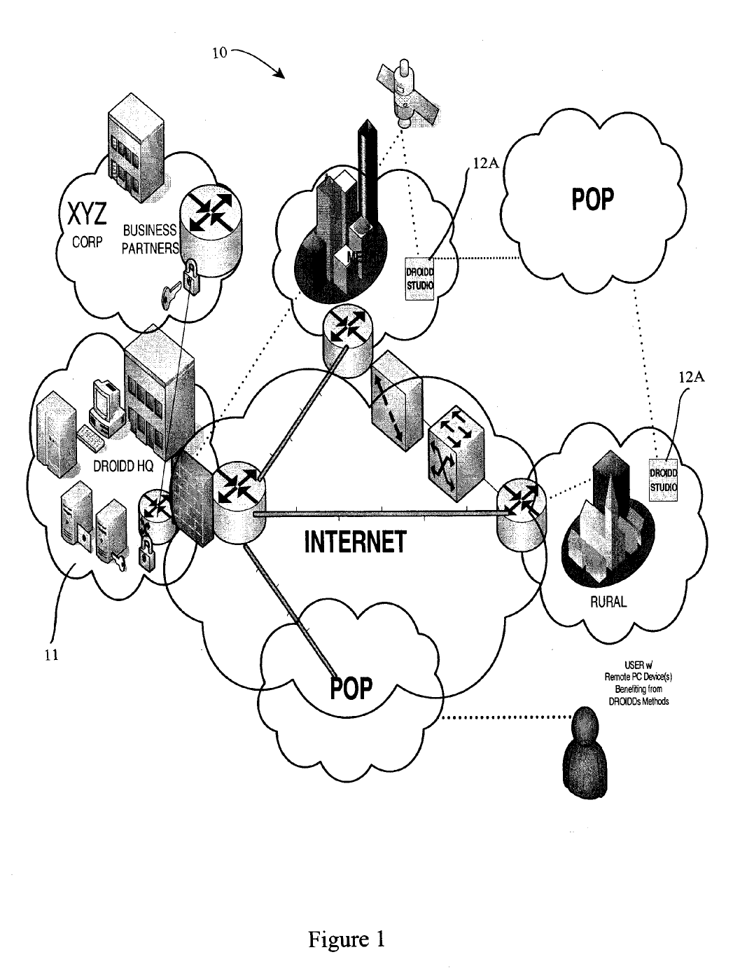

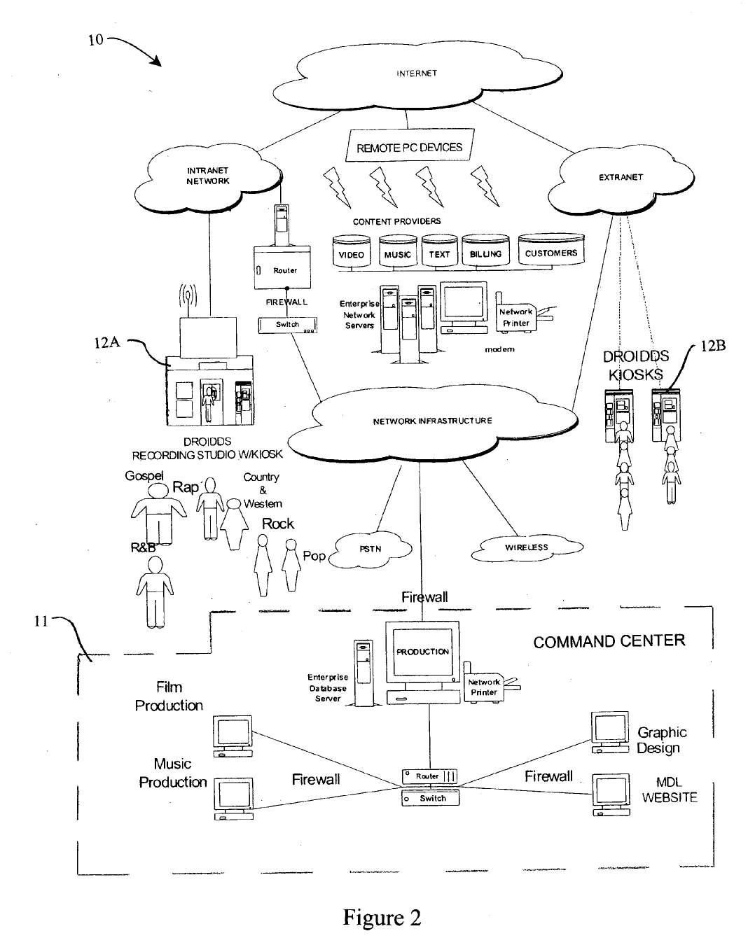

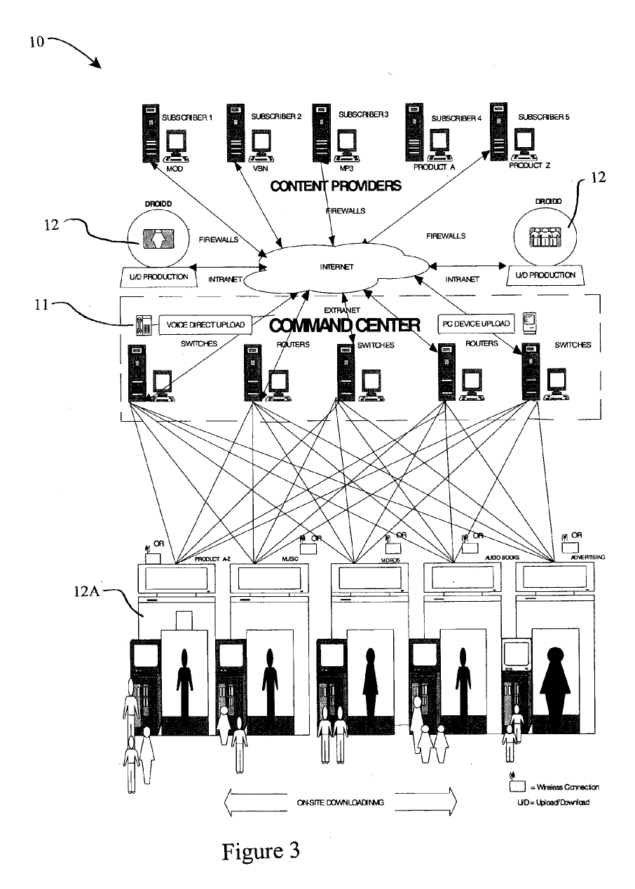

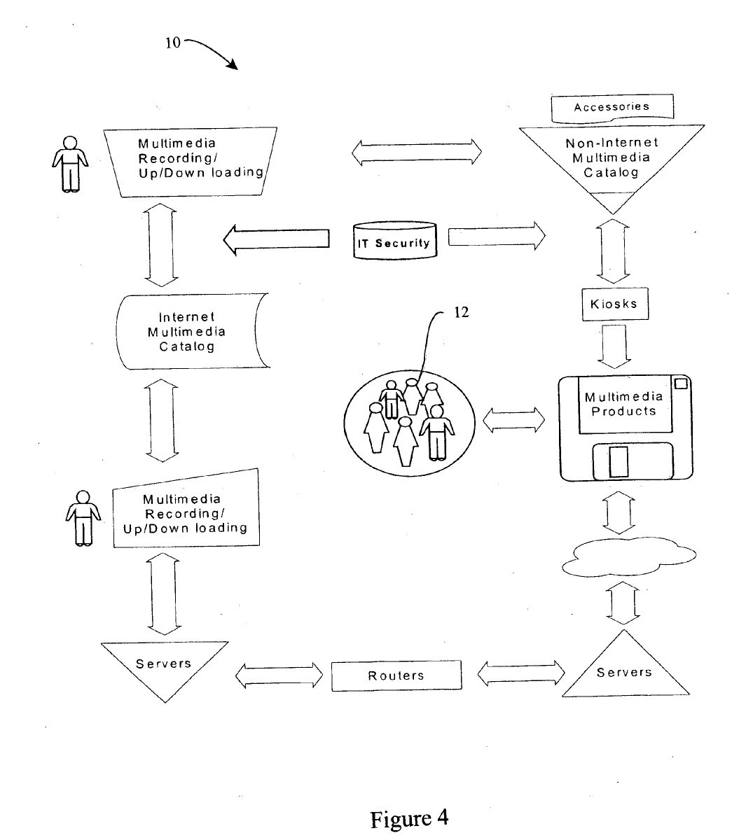

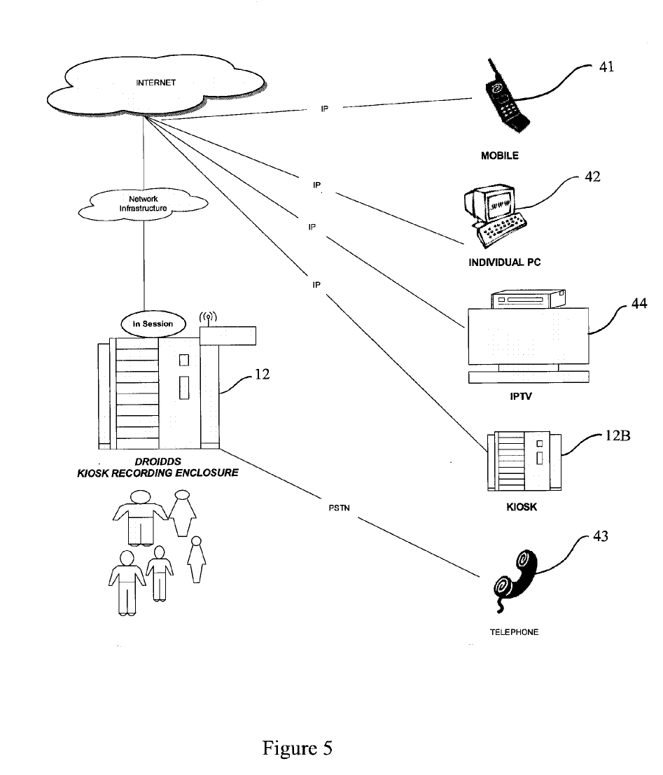

Referring now specifically to the drawings, a multimedia distribution network for distributing audio, video, or various other materials to consumers according to an embodiment of the present invention is illustrated in FIGS. 1-5, and shown generally at reference numeral 10.

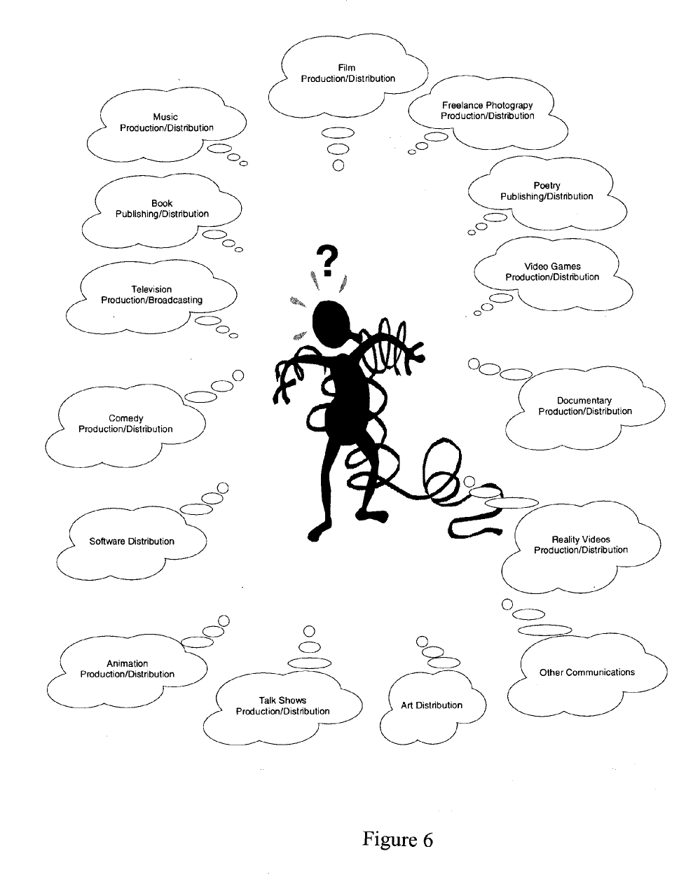

The network 10 includes a command center 11 connected via a communications system, described below, using a hard-wired or wireless transmission system, such as Direct Broadcast Satellite (DBS), synchronous data link control (SDLC), bisynchronous communications, and transmission control protocol/internet protocol (TCP/IP) to a plurality of digital recording on-site interactive downloading devices (DROIDDS) 12, cellular phones 41, personal computer devices 42, Kiosks 12B, land-line telephones 43, IPTV 44, and any other suitable downloading device through an internet or intranet environment. The command center 11 stores recorded materials, such as audio and video including music, poetry, comedy, independent films, audio books, ringtones, and wallpaper for distribution and includes a plurality of network and communication services, such as servers, routers, and switches which are responsible for blanket transmitting the materials to a consumer's personal computer device and the DROIDDS 12 which may be located at various locations such as colleges, shopping malls, restaurants, bookstores, bowling alleys, skating rinks, and coffee houses. As shown in FIG. 6, the network provides a consumer access to a production, distribution, and downloading device that is normally reserved for professional performers.

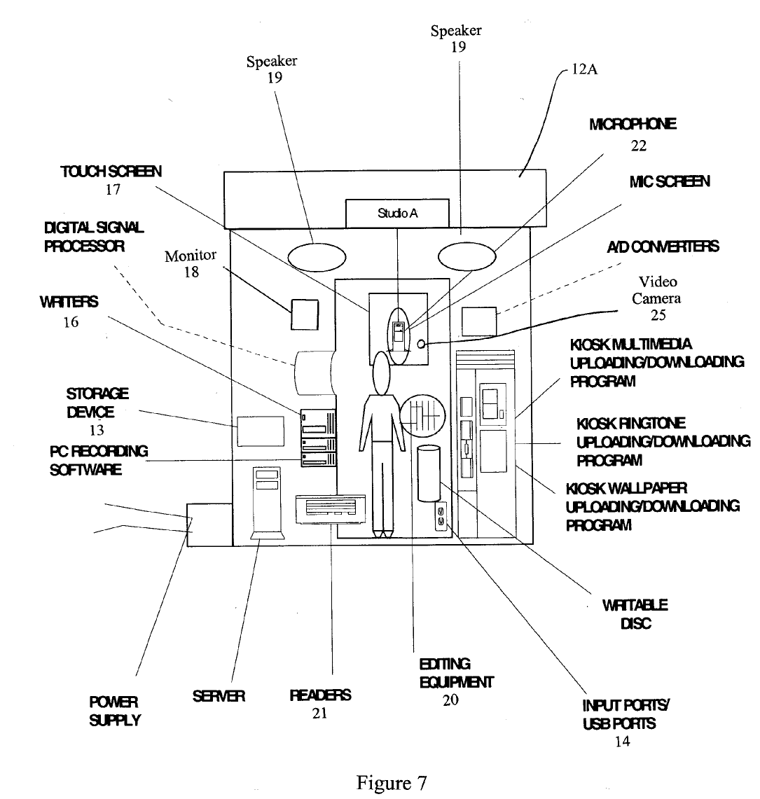

Two types of DROIDDS 12 are used to communicate with the network, the first being a recording enclosure, such as a studio 12A for allowing a consumer to upload and download material to and from the command center, and the second being a kiosk 12B which can operate as a stand alone unit or in combination with a studio 12A, illustrated in FIG. 7, for downloading material from the command center. For purposes of downloading material, the kiosk 12B and studio 12A operate in the same manner and incorporate many of the same features, however, the kiosk 12B does not incorporate any of the features that allow a consumer to record and upload material for distribution. Thus, for clarity, the discussion below will be limited to the studio 12A only.

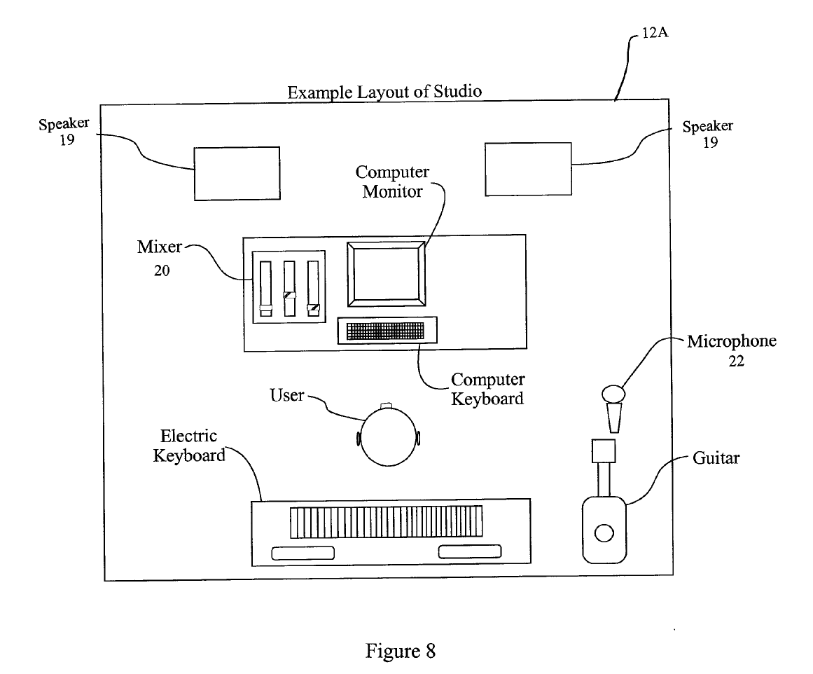

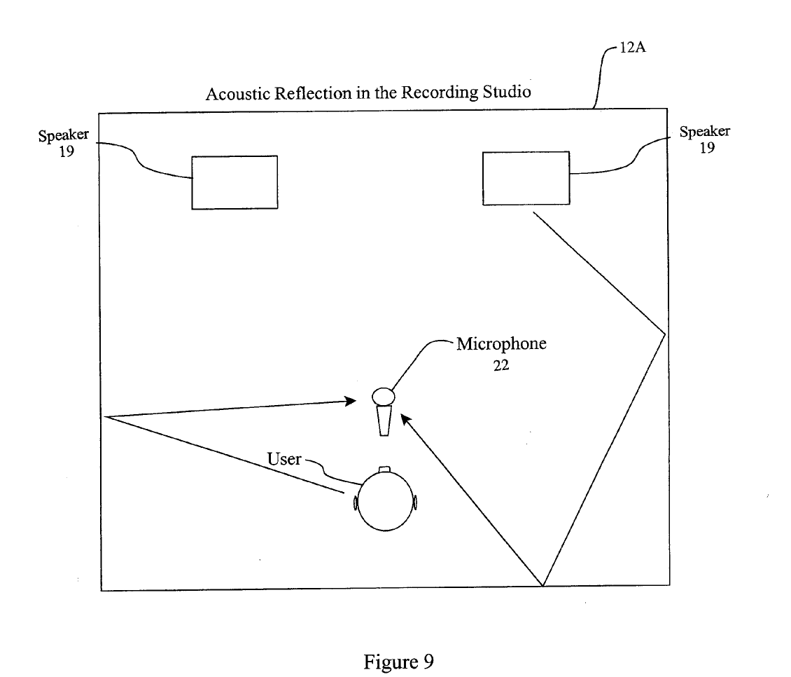

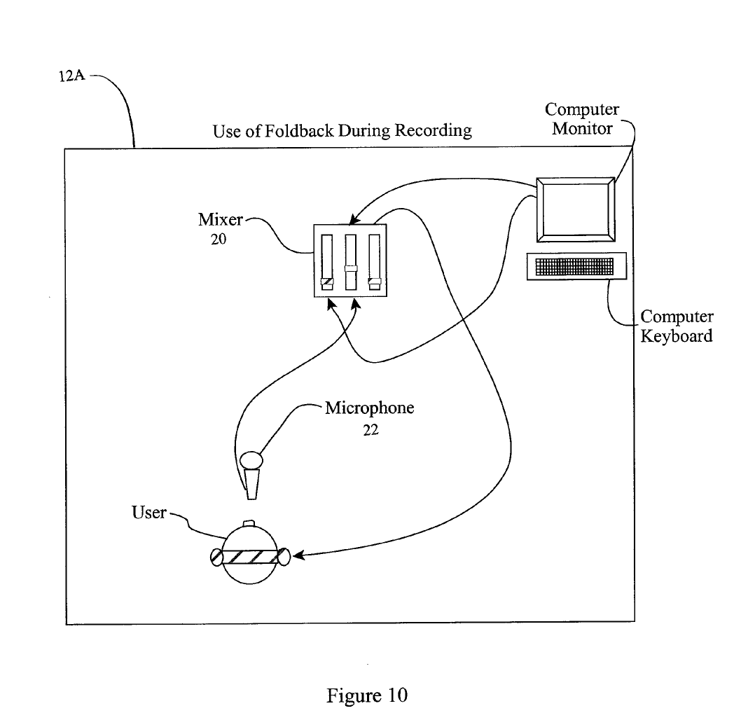

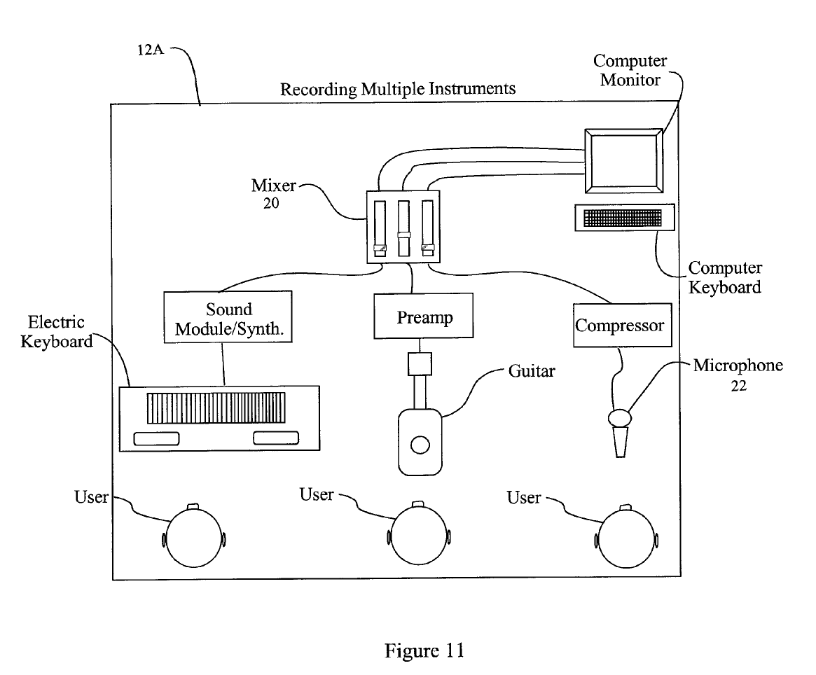

As shown in FIGS. 7-11, the studio 12A is designed to provide a consumer with all of the necessary equipment needed for recording, editing, and uploading material for distribution to other consumers. The studio 12A is constructed to provide a “dead-room” environment and operates using an operating system such as that used on personal computers and includes many of the components that are found in computers such as storage devices 13, USB ports 14, and CD and DVD writers 16. In addition, the studio 12A includes an LCD touch screen 17 for inputting commands to the studio 12A, a monitor 18 for video playback, speakers 19 for audio playback, editing software such as multi-track wave editors and sequencers to produce high quality recordings and provide effect plug-ins, editing equipment 20, a video camera 25 and lights for shooting a video, media readers 21 such as a VCR, DVD and CD player, microphones 22 (including large and small diaphragm condenser microphones) for allowing consumers to spontaneously record and upload a performance, and payment devices such as a credit card reader.

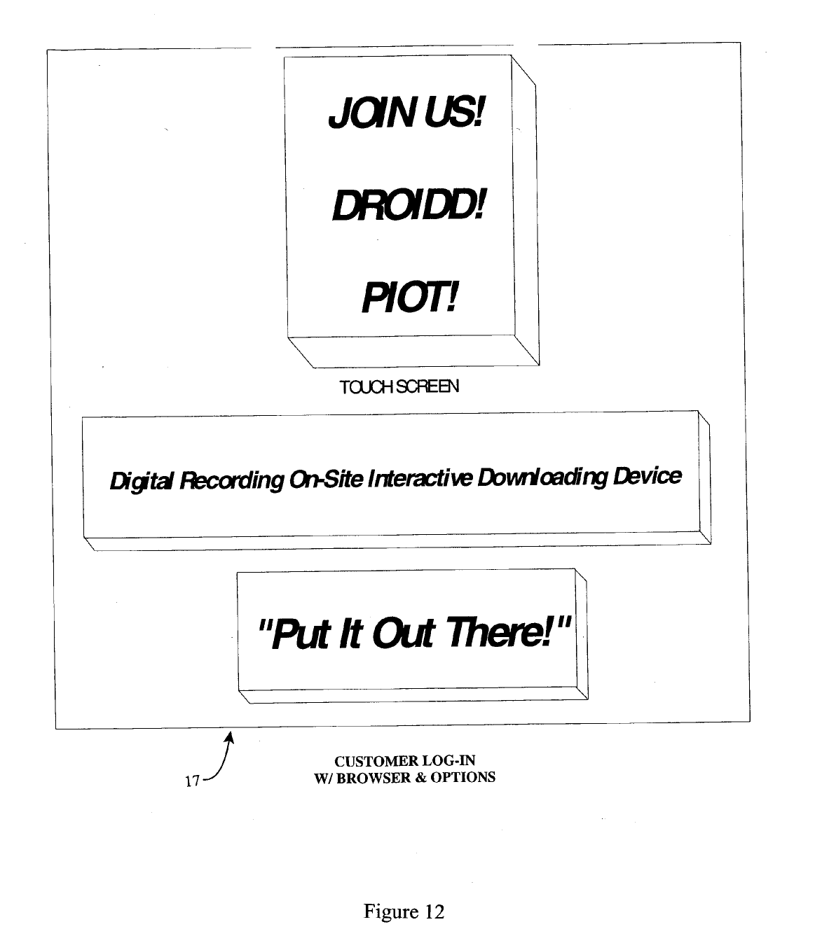

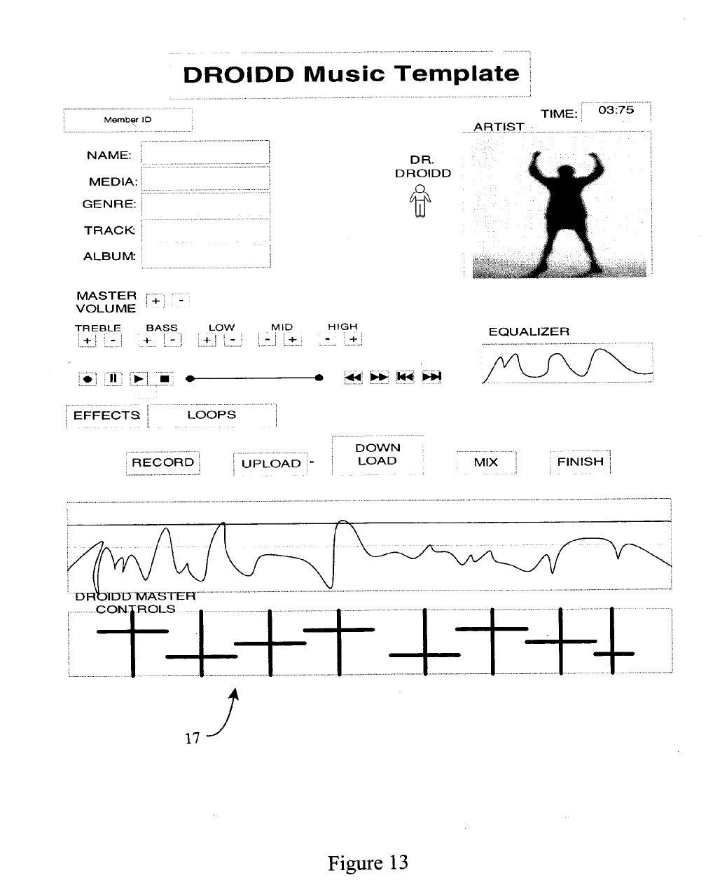

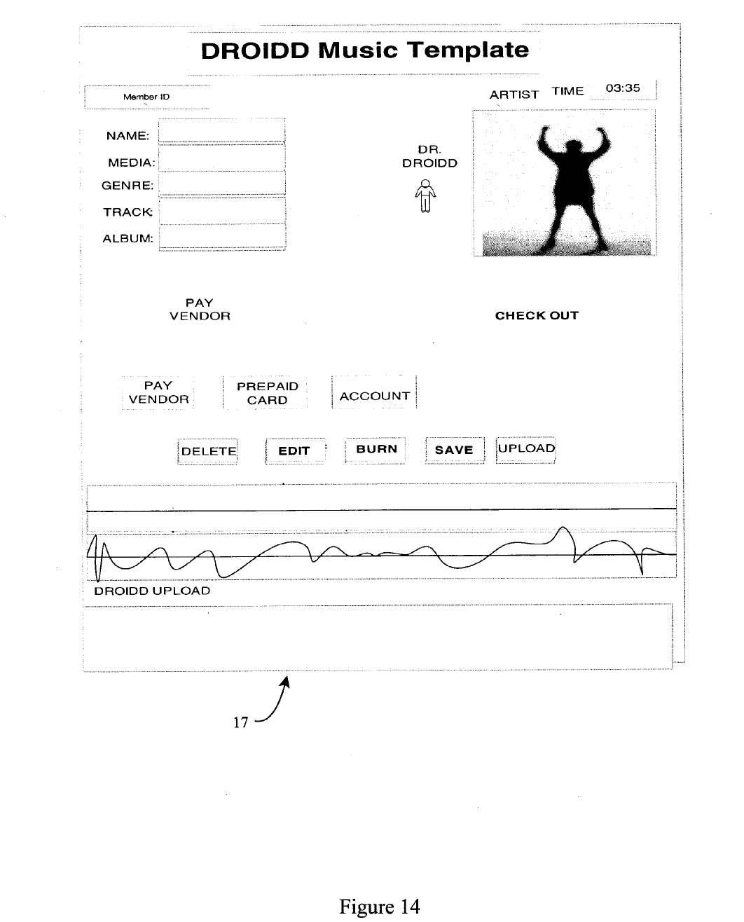

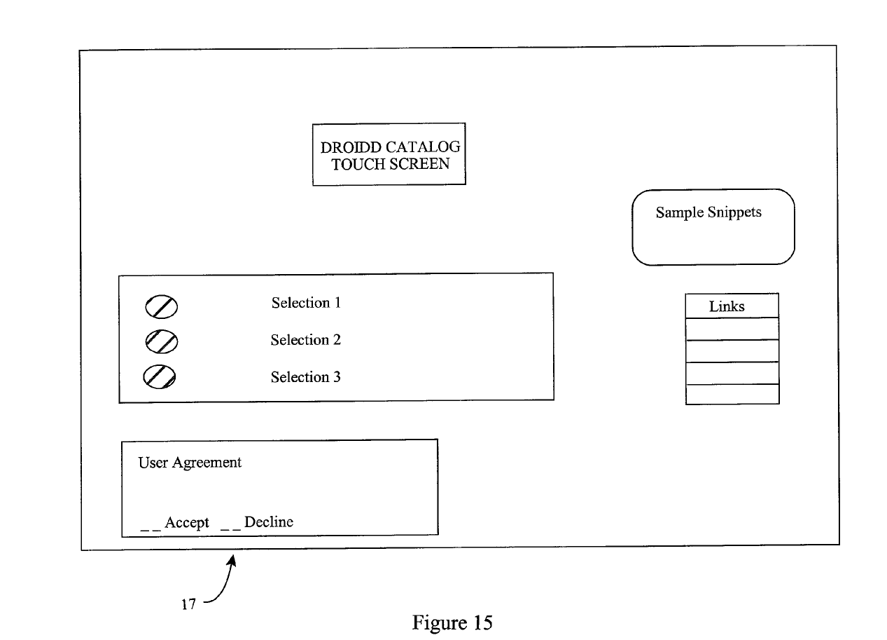

The studio 12A utilizes a menu driven, graphical user interface, illustrated in FIGS. 12-15, in combination with the LCD touch screen 17 to control the uploading and downloading of materials and allow the consumer to enter media, production, promotion, and distribution preference information. The touch screen 17 allows a consumer to sample, select, download, burn, and purchase digitally recorded products via direct point of sale communications, as well as, browse a catalogue of available materials or search the catalogue by artist, title and category (e.g., hip-hop, country, jazz, classical, rock, etc.). The touchscreen 17 also allows consumers to edit recorded materials before uploading the material to the command center for distribution.

The studio 12A allows consumers to produce, promote, manufacture, and distribute previously recorded materials or recordings which are spontaneously performed. The studio 12A can be used to record a solo performance or a group performance performed by individuals located at multiple locations, then upload the recording via a secure connection to the command center 11 where the recording is stored and distributed. Kiosk media download technology is incorporated into the studio 12A to allow consumers to purchase professionally recorded music tracks, sound effects, and samples that can be used as background music or to provide sound effects to their uploaded materials, such as films, poems, and recorded spontaneous live performance.

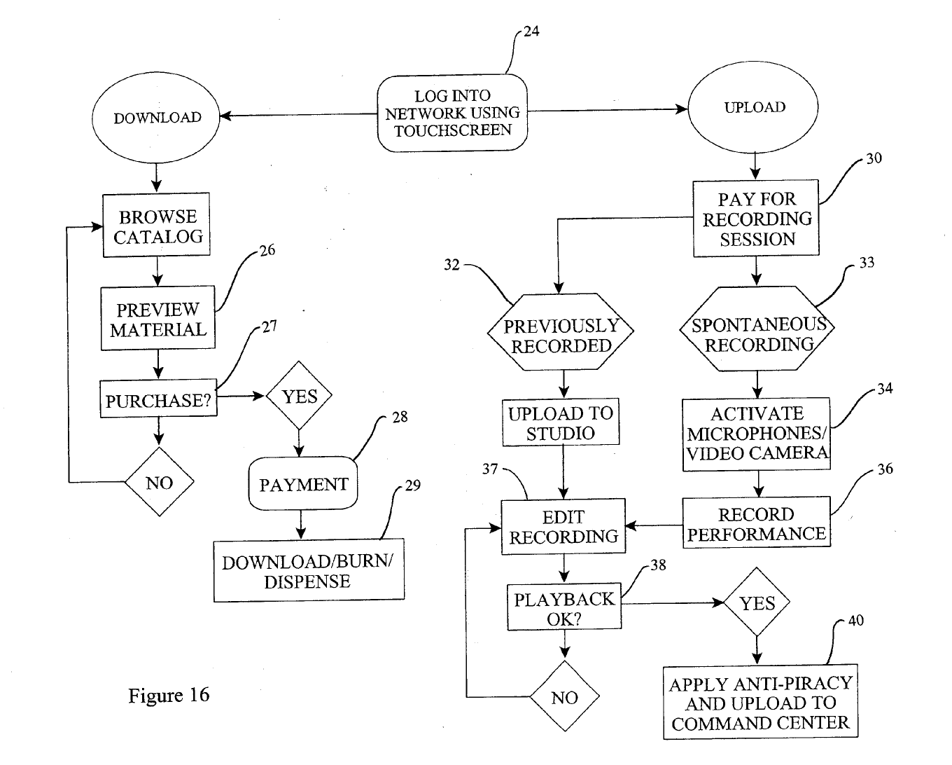

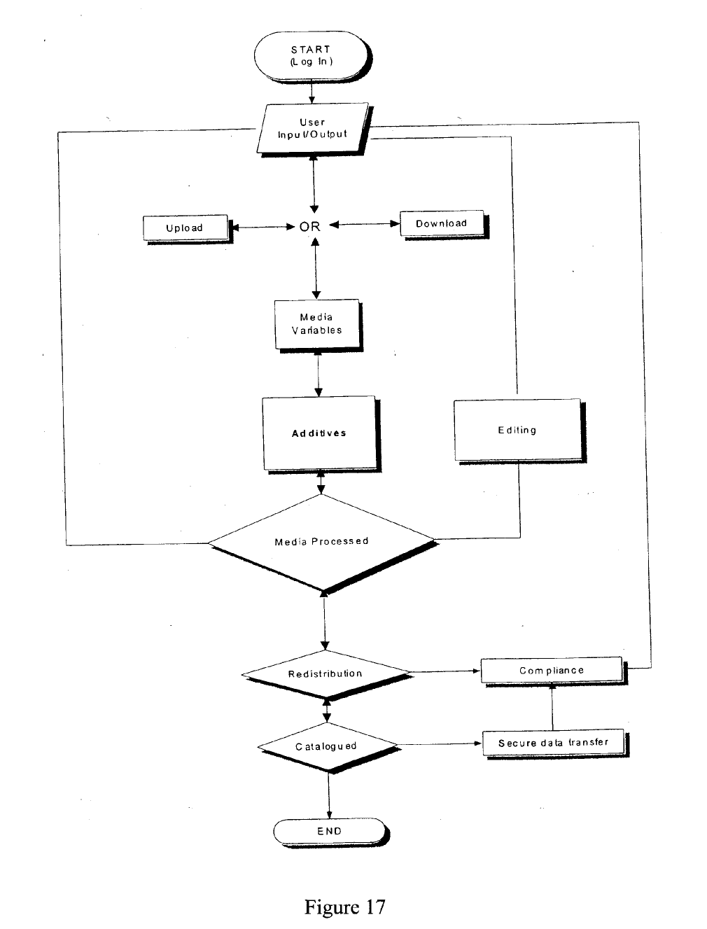

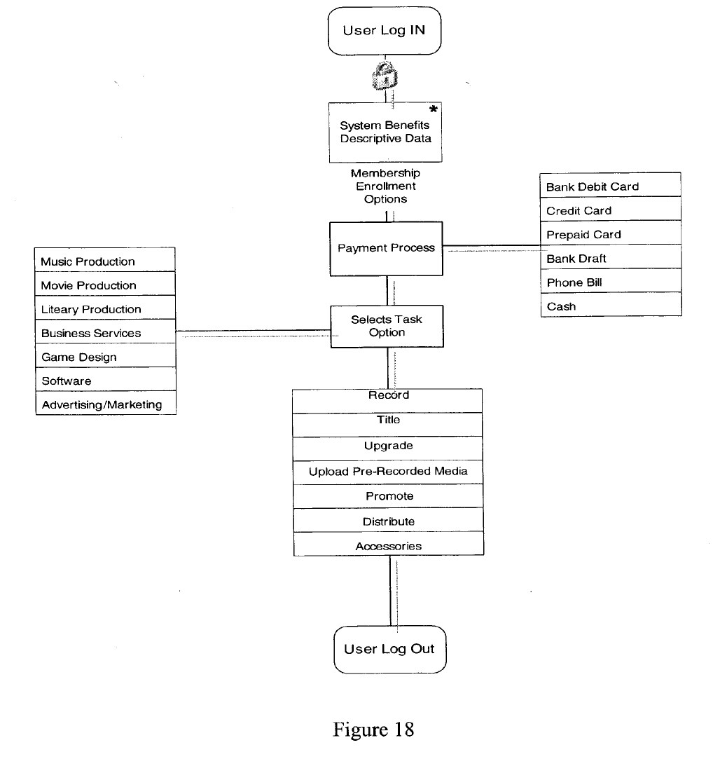

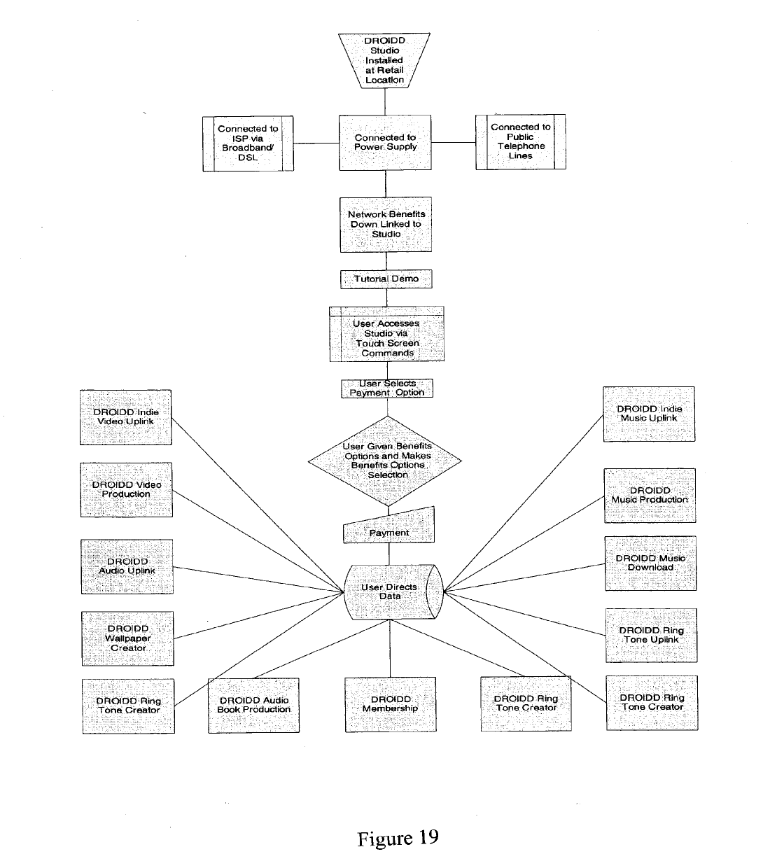

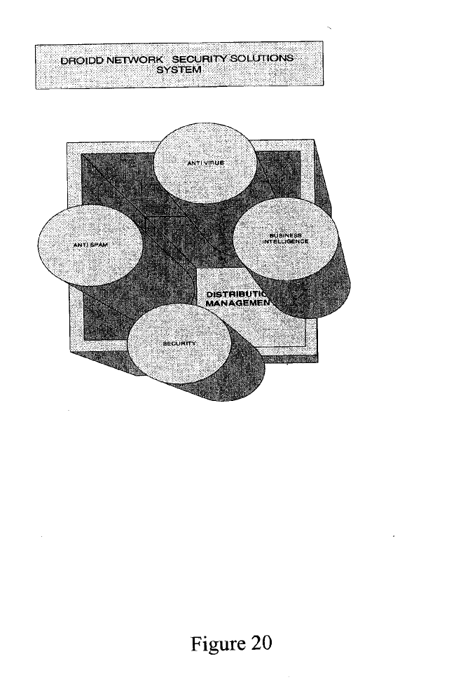

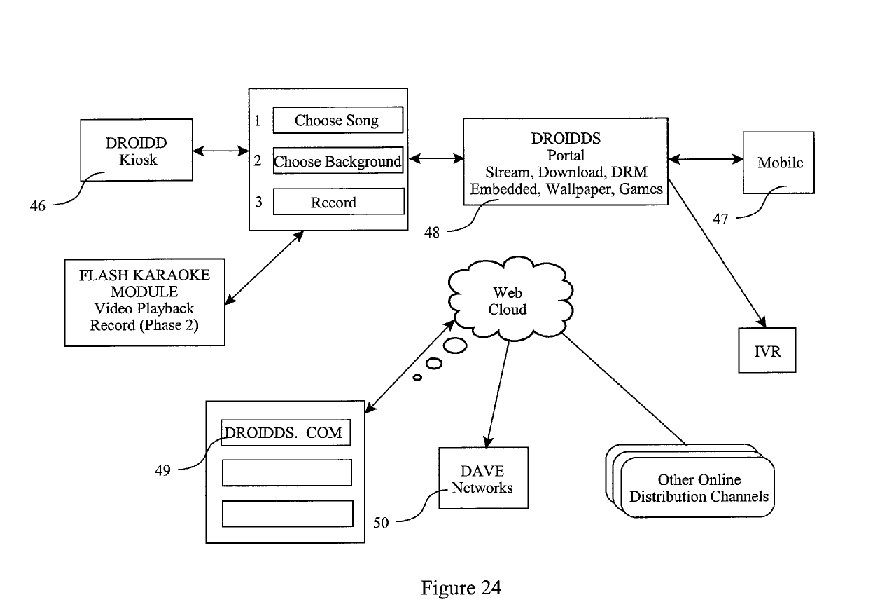

Referring now to FIGS. 16-19, a consumer can download materials using the studio 12A by first using the touchscreen 17 to log into the network and then catalogue browse through categorized and sub-divided media files for pre-selection shopping from tens to thousands of recordings that are transmitted to and stored by the command center 11. The consumer can first log into, Block 24, a personal homepage, as shown in FIG. 24, or directly to the main screens of the network. The customer may browse and preview, Block 26, the stored material for free and thereafter decide whether to purchase, Block 27, a permanent copy. If the purchase decision is made, the studio 12A prompts the consumer to pay, Block 28, for the selected materials by credit card or other acceptable electronic payment. After payment, the command center 11 sends the material to the studio to download, burn, and dispense the selected material to the consumer, Block 29. A full quality CD, DVD, MP3, or other suitable format is recorded by the studio 12A using a CD, DVD, MP3 or other suitable writer. During the recording process, an ID tag is woven into the recorded media so that any illegal copies produced therefrom may be prohibited and traced to the purchase transaction. As shown in FIG. 19 various security devices such as anit-virus software may also be employed. The recording is then dispensed to the consumer.

Alternatively, a live attendant may be available for payment of the selected materials, for mass duplication of the materials, for personal assistance, or for the sale and marketing of accessories to enhance the consumer's downloading experience.

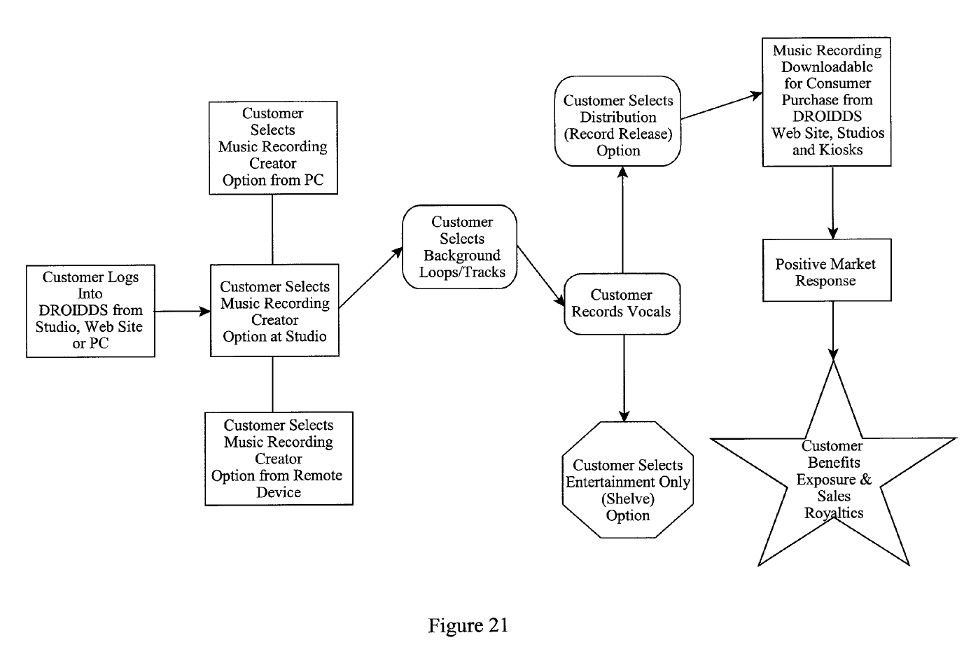

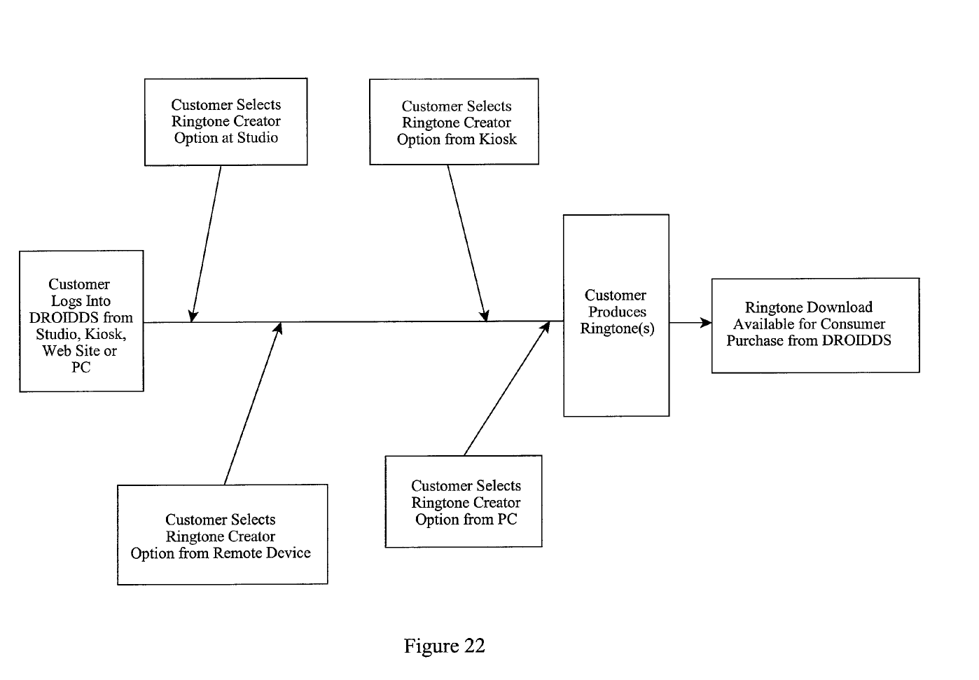

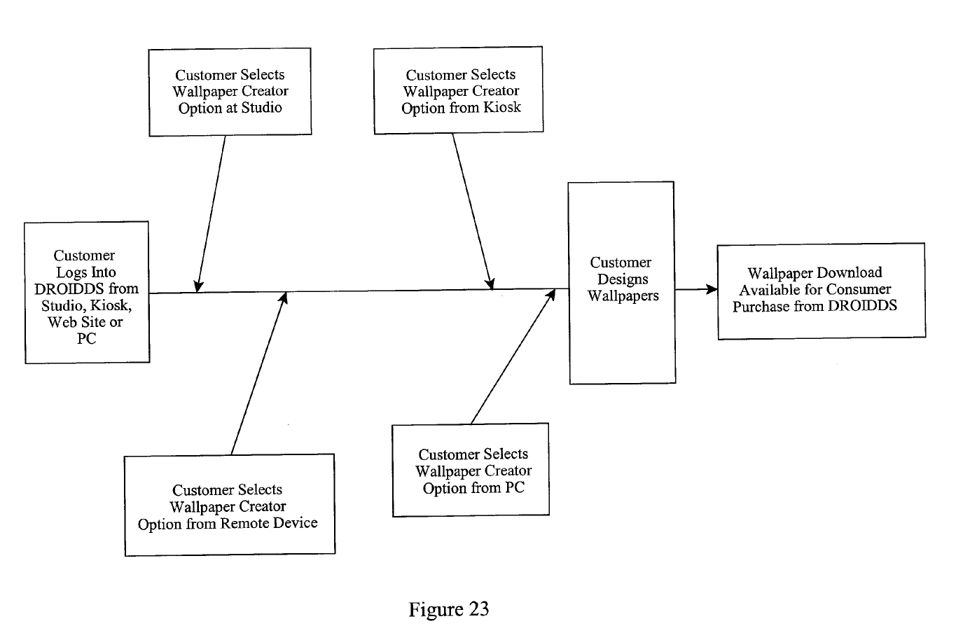

Any digitally recordable appropriate content may be uploaded and distributed to consumers both online and offline via the studio 12A. For example, a consumer can create a music recording and distribute it as shown in FIG. 21. A consumer may also create ringtones and wallpaper for distribution, as shown in FIGS. 22 and 23. To upload a previously recorded performance or to record a spontaneous performance, the consumer enters the studio 12A and pays for a recording session, Block 30, which lasts for a specified amount of time which is extendable by further payments. The consumer is also prompted to agree to give as consideration for distribution of the consumer's material a share of the proceeds generated by the distribution network.

If the consumer desires to upload a previously recorded performance, the consumer inserts the CD, DVD, or other format that the performance is recorded on into one of the writers 16 or readers 21 and pushes the upload icon on the touchscreen 17, directing the writer 16 or reader 21 to read and save the recorded material locally, Block 32. If the consumer desires to upload a spontaneous performance, Block 33, the consumer activates the microphones 22 or video camera 25 and begins performing, Block 34. The studio 12A records the performance and saves it locally, Block 36. Once the previously recorded or spontaneous performance has been saved locally, the consumer can edit, Block 37, the material by adding professionally recorded tracks, adding effects, or changing various characteristics of the material, such as treble and bass. The recording can then be played to allow the consumer to review the finished product, viewing a video recording on the monitor 18 or listening to audio through the speakers 19, Block 38. The consumer is also given the option of applying anti-piracy protection, Block 40, to the edited version before uploading it to the command center, protecting the consumer's proprietary interests. The edited version of the material is then saved and uploaded to the command center 11 where the material is stored and made immediately available for distribution to consumers.

Upon completion of the recording session the consumer leaves the studio 12A with an encrypted copy of the stored material and incurs no further obligation to the distribution network. Thereafter, the consumer collects royalty payments from the distribution network for each purchase of the consumer's material. The consumer is instrumental in setting the purchase price of the material on a daily basis, as well as promote the material through various sales incentives.

Referring to FIG. 24, as an example of a another embodiment, a DROIDDS recording software application will be installed to allow users to capture a karaoke performance (with lyrics being displayed across the touchscreen) as well as original lyrics being recorded over an instrumental track. This can be accomplished inside the studio, Block 46, or from a remote device, Block 47, connected to the studio command server network, Block 48. Also, a green screen background may be utilized inside the studio and a home version green screen utilized for remote users allowing users to select a background for their performance. The recording software may also be downloaded to the user's remote PC device to provide the user with a virtual DROIDDS studio experience, Block 49. As depicted, DAVE networks, Block 50, are used to allow the user's content to be broadcast on IPTV, as well as, other previously identified channels.

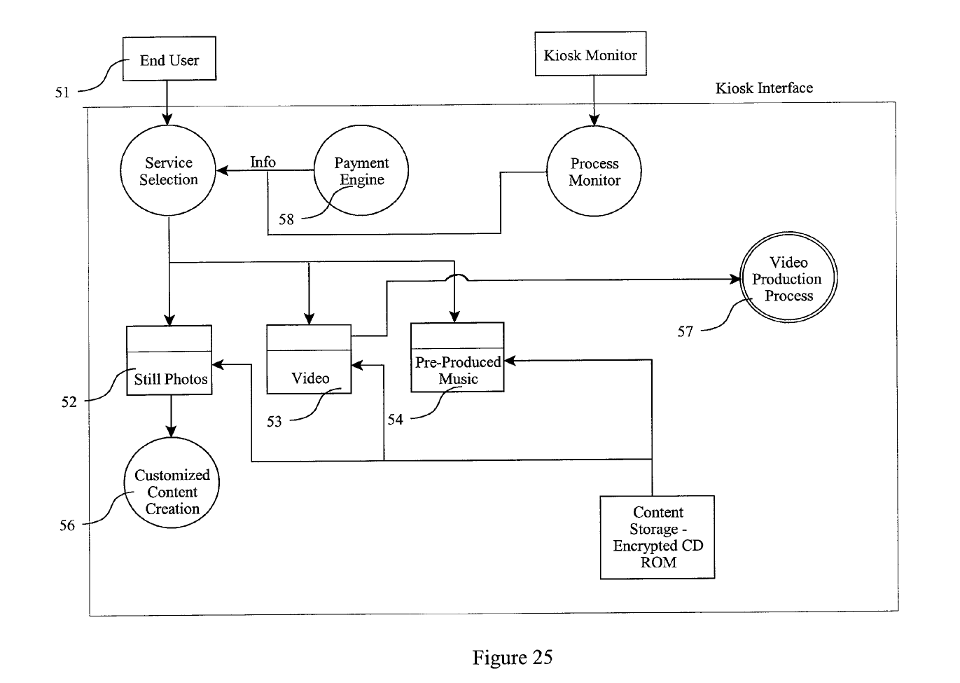

FIGS. 25-27 further explain various elements of FIG. 24. As shown in FIG. 25, Block 46 of FIG. 24 can be broken down further. As illustrated, an end user, Block 51, can choose between various types of content, such as still photos, Block 52, video, Block 53, pre-produced music, Block 54, as well as customizing a creation, Block 56, and a video production process, Block 57. The end user, Block 51, is also prompted for payment, Block 58.

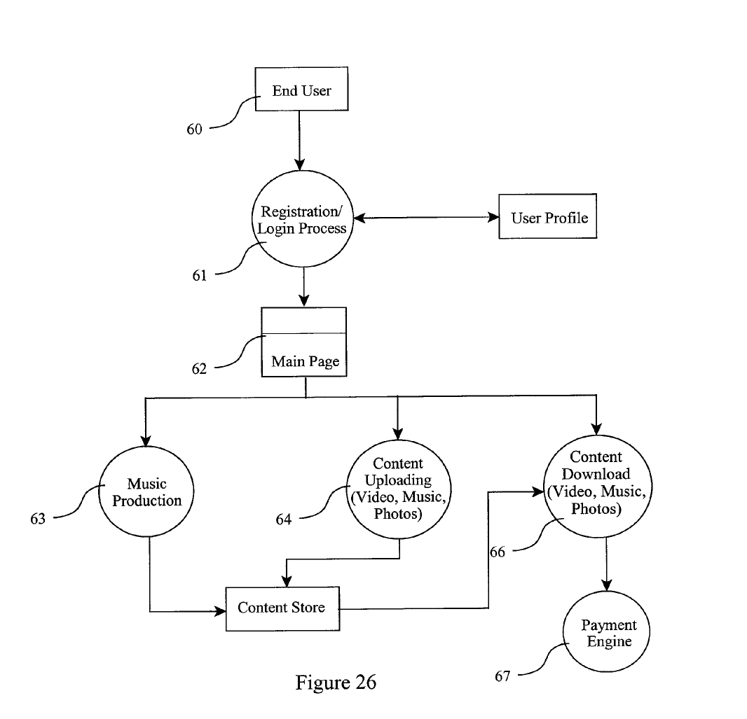

As shown in FIG. 26, Block 49 may be further broken down. As illustrated, an end user, Block 60, registers or logs into the website, Block 61. The end user, Block 60, is sent to the main page, Block 62, where the user can decide between music production, Block 63, content uploading, Block 64, and content downloading, Block 66. The end user, Block 60 is also prompted for payment, Block 67.

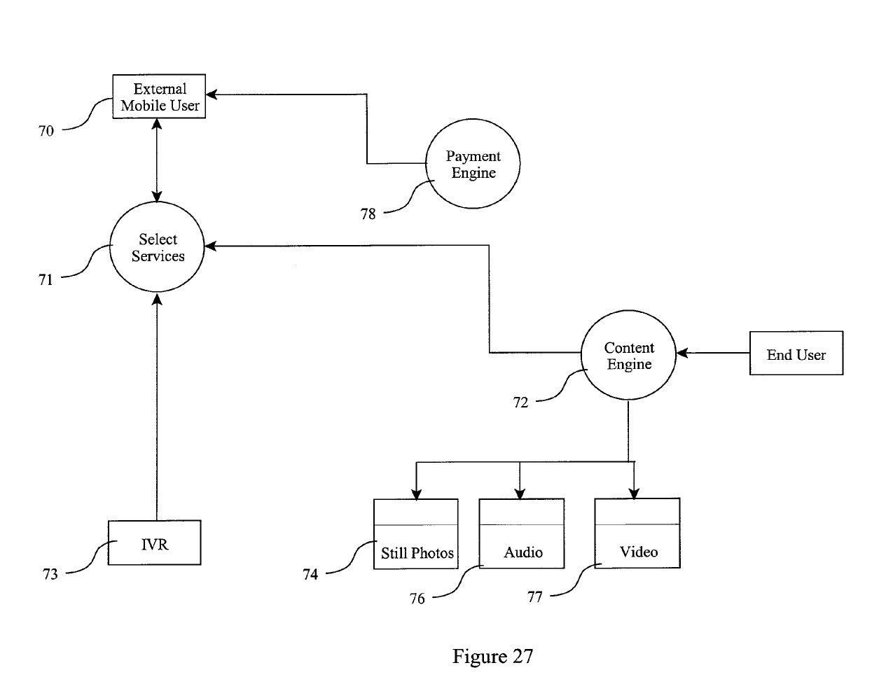

Referring to FIG. 27, Block 47 is further defined. As illustrated, an external mobile user, Block 70, selects services, Block 71, from a content engine, Block 72, or an IVR, Block 73. The services can include still photos, Block 74, audio, Block 76, video, Block 77, and other suitable services. The user, Block 70, is prompted for payment, Block 78.

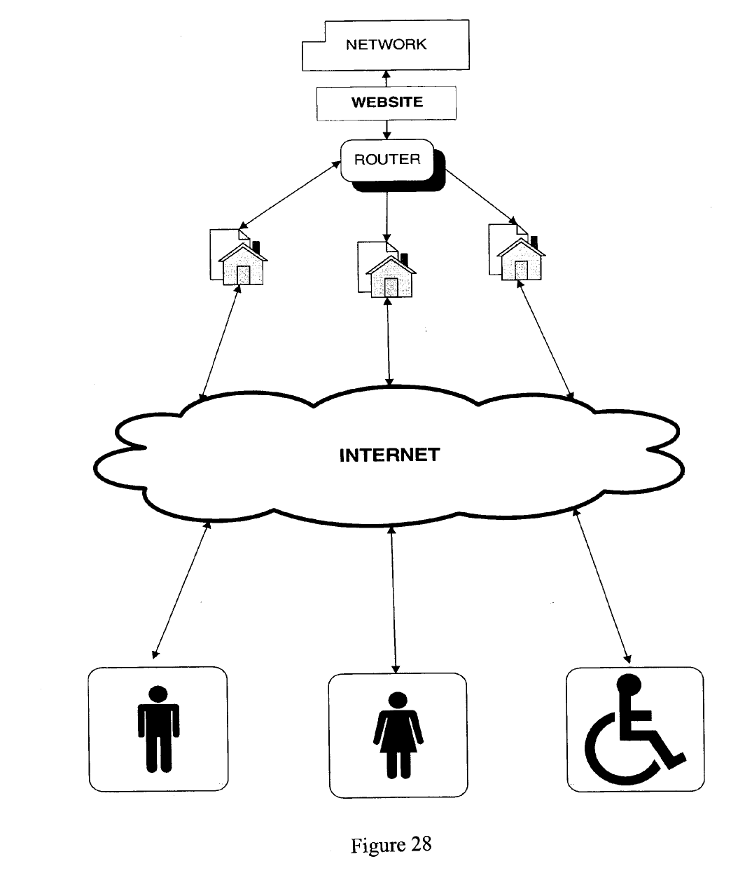

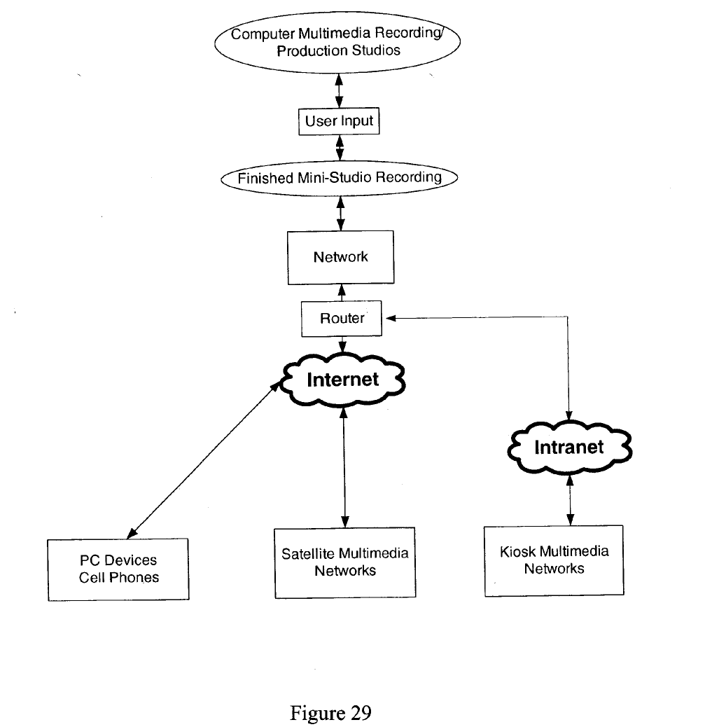

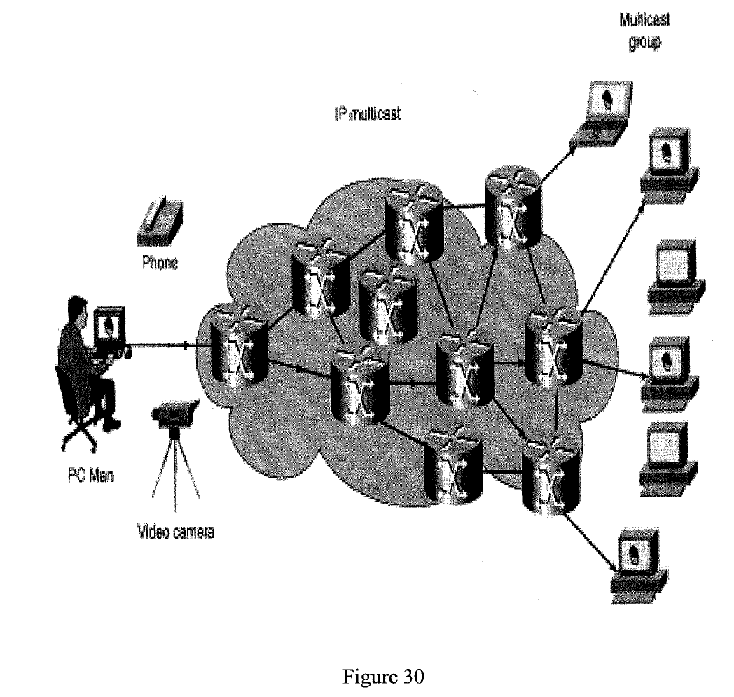

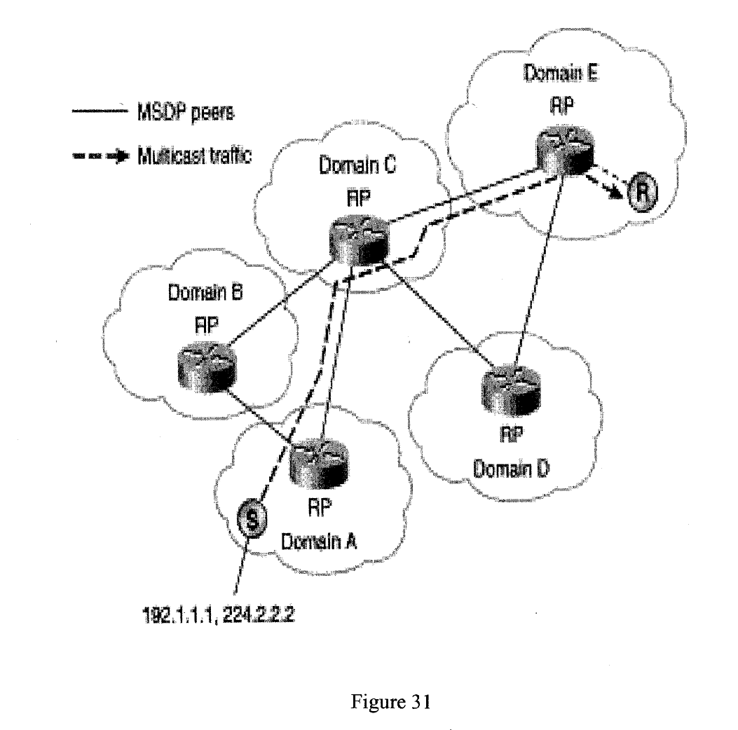

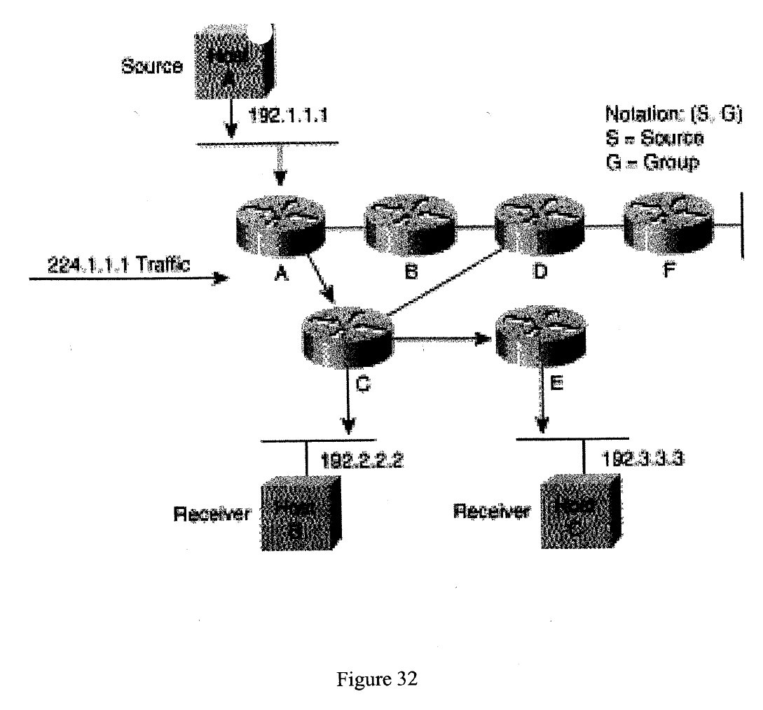

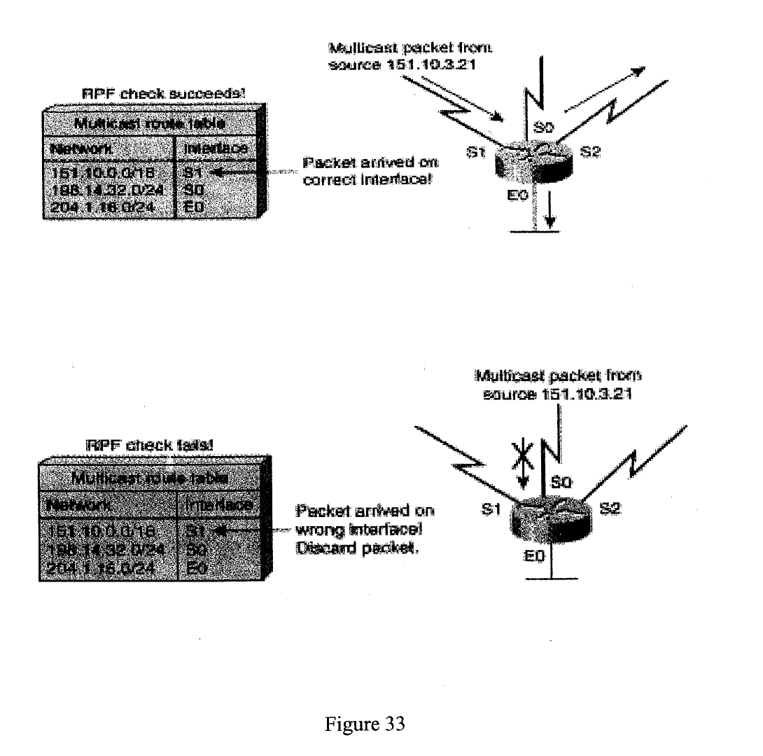

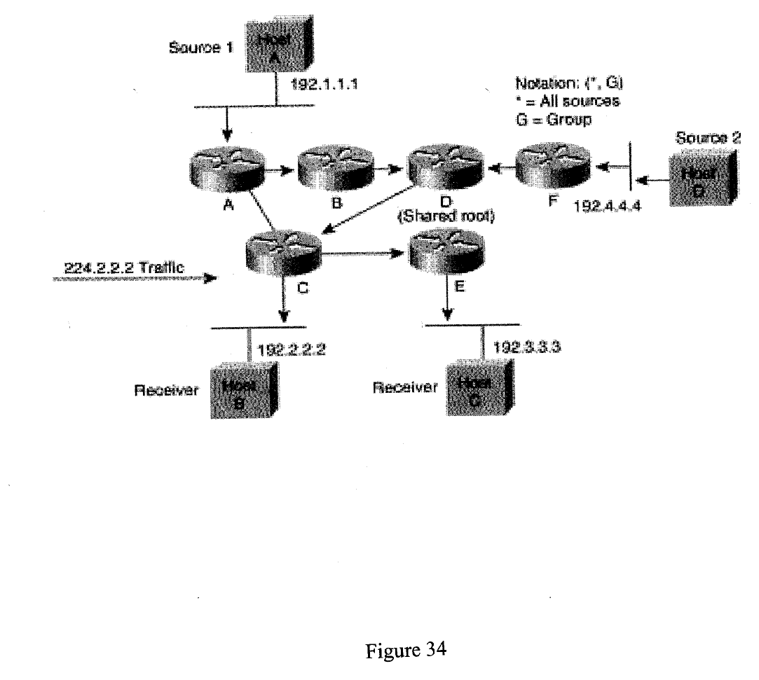

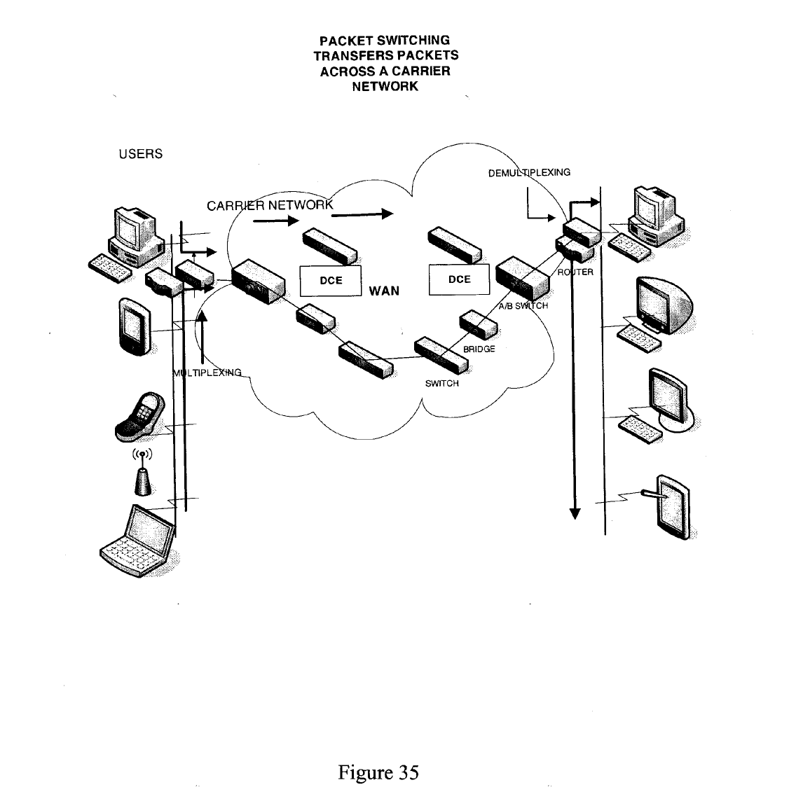

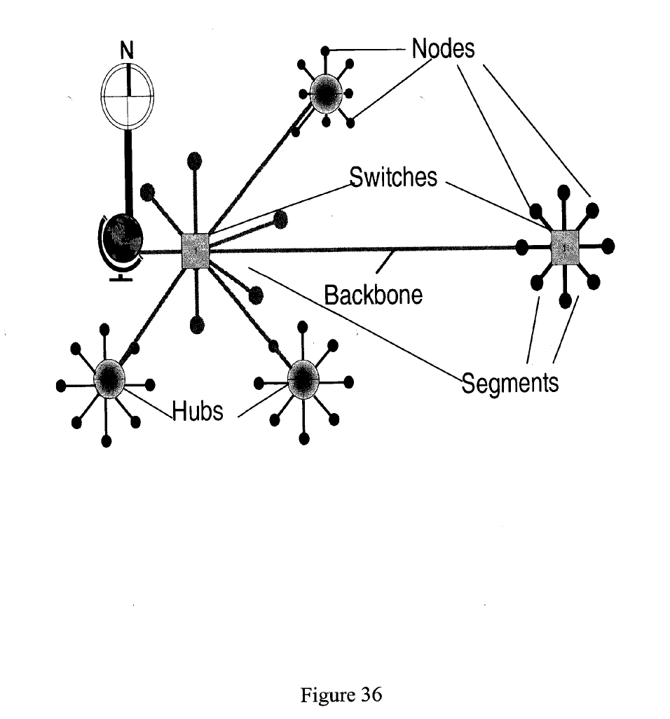

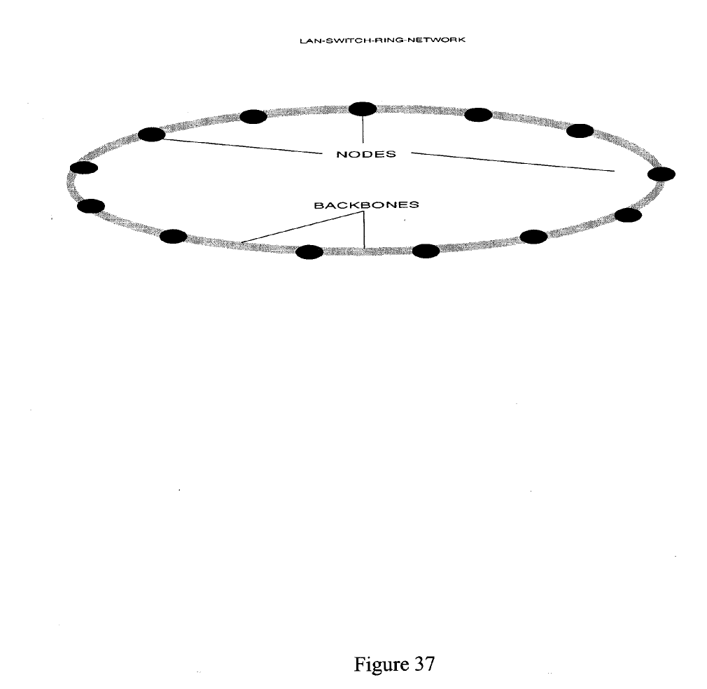

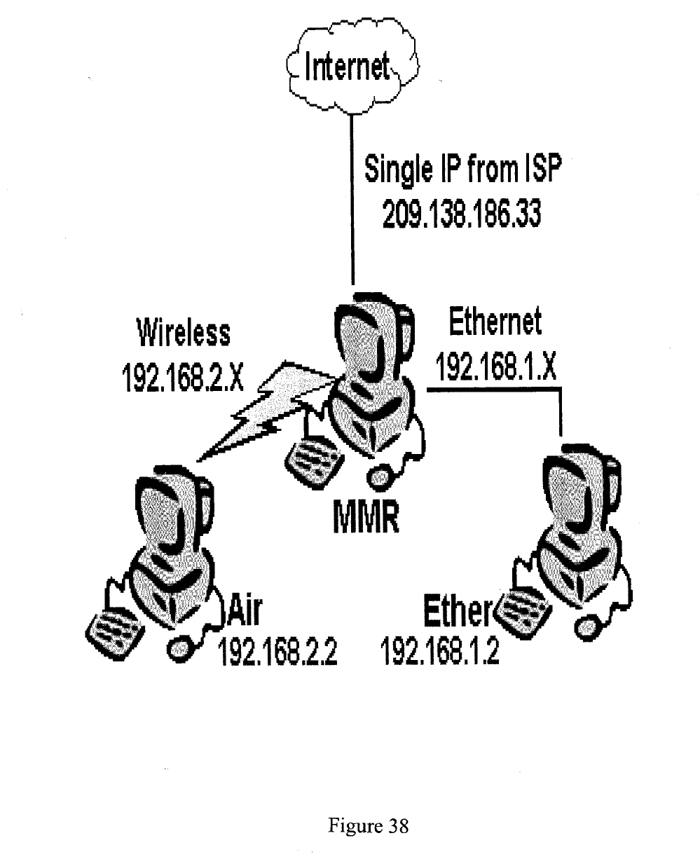

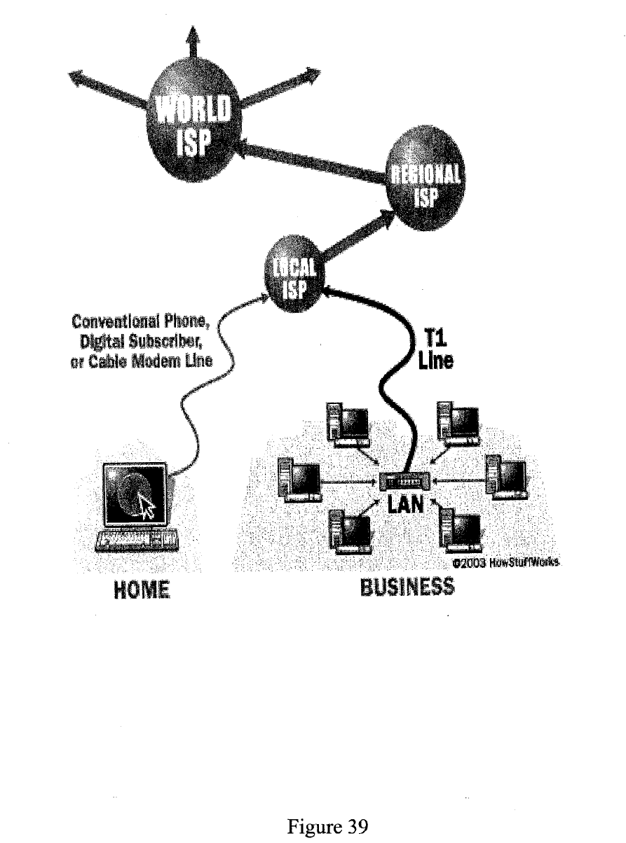

Referring now to FIGS. 28-39, the communications system uses various types of networks connected to the command center such as a WAN network, a high-speed telephony network, a fiber-optic network, a cable network, multiple IP networks, Internet and Intranet networks, multicast networks, P2P networks, a MSDP network, and a LAN network to allow material to be transmitted more efficiently.

The communications system is capable of interfacing with the various networks and their respective formats, such as digital music and video. For example, a telephony network and an IP network having different formats could be connected to the invention. The telephony network could be running on a coax cable while the IP network could be wireless. Additionally, the digital music and video received by the invention could be transmitted to another network to serve as background for audio voice data.

The communications system includes a first network interface, a second network interface, a shared non-switched system bus, and a processor. Each network interface, includes a physical interface mechanism for connecting with an attached network, such as through links connecting to other networks respectively. The first network interface is connected to a first network and exchanges data in a first network format with the first network. Similarly, the second network interface is connected to a second network and exchanges data in a second network format with the second network. The shared non-switched system bus connects the first network interface and the second network interface. The processor is operably connected to at least one of the first network interface, the second network interface, and the shared non-switched system bus.

The communications system can also interface networks having different network protocol layers, network transport or media layers, or one or more other layers. A preset number of network layers from different networks may be encapsulated as payload and transmitted between different networks without requiring any comparisons or translations. For instance, layers 2 through 7 of TCP/IP networks operating on different physical layers or media, such as on fiber-optic and wireless, could be encapsulated and transmitted as payload across TCP/IP networks having different physical layers or media.

The network interfaces are capable of exchanging data bi-directionally in an interleaved manner with another network interface to improve the performance of the distribution network. Each network interface may comprise a single port customized for interfacing with a given network in a given network format.

The network interfaces may include a physical interface mechanism, such as an RJ-45 connector for physically attaching to the network. The processor could accordingly connect directly to the network through the physical interface mechanism of the network interface and interact with the network without requiring additional intervening specialized interface hardware. The network interfaces further include support for data link or higher layer networking functions.

The network interfaces may also be memory mapped and assigned a range of unique memory addresses associated with the interfaces. Memory mapping interfaces helps support data exchanges performed through the communication system. Software switched transmission of data, other programmed transfers of data or parameters, and establishing software switched logical connections between network interfaces are among the communication system functions that can be supported by memory mapped network and external interfaces. Memory mapping interfaces may also allow software customization and control of network transmission/receive parameters, network interface controls or the like, for the network or external interface. Memory mapped access to network interfaces or other external interfaces also supports autonomous and efficient transfers of data between interfaces.

The processor may be contained within a network interface and operably connected to that network interface or to one or more network interfaces. Further, the processor may be connected either directly or indirectly through a shared non-switched system bus to at least one network interface. The shared non-switched system bus operably connects the first network interface and the second network interface.

The processor executes a suitable software program for translating between network formats. The processor provides intelligent and transparent exchanges between networks while reconciling different forms of data, different types of information, and different network formats. The received data or information can be translated from the network format as received from a respective network into a transparent format, allowing direct transfers between network interfaces without any intervening hardware switching or routing devices between network interfaces.

The processor is required to translate or convert incoming data from the incoming network format to a transparent format, and optionally to inverse translate or convert data from the transparent format to the outgoing network format. In addition, a processor or programmable controller is also required to perform software switched transmission of incoming data directly from one network interface to another network interface. Further, a processor or programmable controller is needed to establish software switched logical connections between network interfaces.

The common transparent format is used to efficiently transport data or information via a software switched transmission through a shared non-switched system bus from one network interface to another network interface. Software executed by the processor can determine the source network interface and destination network interface, and establish a software switched exchange of data between network interfaces using the common transparent format. By using a common transparent format it is possible to software switch and direct incoming data transparently between network interfaces, without regard to the incoming network format and the outgoing network format. A common transparent format therefore allows data or information in any form and in any network format to be processed and conveyed transparently through the communication system. Data in the common transparent format can also be inversely translated from the common transparent format into an outbound network format. Once represented in the outbound network format, data or information can thereafter be transmitted through the outbound network interface.

Translating received data from an incoming network format to the common transparent format requires both decoding and encapsulation processing. The incoming data in an incoming network format can be decoded by extracting it from one or more network layers of a network layer model as required to create the payload or decoded data. The payload or decoded data can then be encapsulated as required to embody it in the desired common transparent format. Once data in the common transparent format has been effectively transmitted to an outbound network interface, the translation can be inverted or reversed. Thereafter, the communication system can decapsulate and encode data from the common transparent format into the network format of an outgoing network. Analogously, the encoding can be applied to one or more network layers of a network layer model as required for compatibility with the outbound network format. As such, the data can thereafter be transmitted out of an outbound network interface to the corresponding outbound network. The communication systems provided can therefore exchange data and information transparently between diverse networks having different network formats.

Exchanges of data in the common transparent format can occur between network interfaces whether or not a software switched logical connection is established between network interfaces. An encapsulated format, such as a hardware-encapsulated format, can transparently carry decoded data between network interfaces, regardless of the incoming network format, outgoing network format, or type of data or information being exchanged.

The decoding function can be applied to one or more of the network layers inherent in the incoming network format. Decoding includes extracting analog voice data from the physical layer of an incoming call on a standard POTS telephone line. Data received in a network format may be decoded or extracted from its incoming physical layer and data link layer, so that decoded data can be represented by the contents of network layers. Depending on the network format and the number and type of network layers to decode, the decoding may be performed by the network interface alone, processor alone, or by both.

Data could be any form of data being received by a network interface in any incoming network format. Optionally, decoded data can be further processed or translated prior to encapsulation, such as to represent decoded data in a format used for transparent exchanges of data between network interfaces. For example, decoded data could be formatted into an IP packet format prior to being encapsulated in some encapsulated format used for transmission between network interfaces. The encapsulated format could be a hardware-encapsulated format for transmitting the IP packet between network interfaces, such as through a PCI bus or some other hardware path between network interfaces.

Incoming data received in any incoming network format could be decoded or extracted and thereafter formatted as decoded data payload contained in an IP packet format for transmission between network interfaces. The IP packet could be encapsulated into an envelope for transmitting the decoded data payload transparently between network interfaces. Data received from a POTS telephony network could be decoded or extracted, and formatted as payload into an IP packet format representing decoded data.

The network can be the Internet or another IP network, while the shared non-switched system bus may be a PCI type bus. The processor can then encapsulate the decoded data, including at a minimum data or at least one network layer, into a hardware encapsulated third format.

The communication system can perform software controlled and software switched transmission of data, and does not require hardware switching devices for its shared non-switched system bus. Further, the communication system may use software commands to establish a software switched logical connection between network interfaces for transferring data between connected network interfaces, preferably but not necessarily through the shared non-switched system bus. The shared non-switched bus could be implemented as a PCI bus, Compact PCI bus, ISA bus, VME bus, VME64 bus, or the like.

The transfer of data or information between network interfaces is accomplished through software executing in a processor. The software can setup the route used for sending and receiving data between network interfaces, thus performing a software switching function. In other words, software can switch data by determining what network interfaces are to exchange data, can enable those network interfaces to exchange data, and can optionally determine whether the data exchange will be unidirectional or bi-directional between network interfaces. Software switching and software enabled transfers of data between network interfaces could occur without logically connecting or associating network interfaces. Software switching does not preclude establishing a logical connection or association between network interfaces for transferring data between network interfaces. Data can be transferred by software switched transmission between network interfaces with or without establishing a logical connection between network interfaces.

The shared non-switched system bus used in the communication system is by definition a common, party line bus without any intervening hardware switching devices disposed between network interfaces, processors, or the like. For example, the shared non-switched system bus connects network interfaces directly without any intervening hardware switching devices. In a like manner, the switching of data between network interfaces is performed under software control, without reliance upon hardware switching devices as duly noted. A processor executing a software program can receive information indicating which network interfaces are to exchange data. The processor can establish a data transfer between those network interfaces, in essence by switching the data using software, and support a software switched transmission of data between those network interfaces. Network interface connection information or a software command can contain parameters indicating which network interfaces are to be logically connected for exchanging data. The processor can use the network interface connection information to establish a software switched logical connection for exchanging data between the specified network interfaces.

Software switched transmission of data can be established by the processor, network interfaces may include a processor or programmable controller therein. A software switched logical connection can be established automatically under software control, without requiring intervention from a user of the communication system, between network interfaces. Software may use network interface connection information to issue commands to the respective network interface or interfaces so as to “introduce” them to each other or to make each network interface aware of other network interfaces with which data may be exchanged. The processor executing software could set-up control blocks in memory to enable transfers or exchanges of data between two or more network interfaces. As a further example, the processor executing software could issue commands to setup memory-mapped transfers, such as DMA transfers, between mutually memory mapped network interfaces. Once introduced, network interfaces can transfer or exchange data directly between network interfaces autonomously and without requiring any additional processor or software intervention.

Data or information may be transferred directly between network interfaces through the software switched logical connection established between transferring network interfaces. Software switched transmission of data is provided with or without establishing a software switched logical connection between network interfaces. Transferring data through a software switched logical connection can simplify the software design significantly. Since a network interface can be addressed by software as a “port”, software commands or the like can be created to simply connect ports together. The software commands used to connect ports together can logically connect two or more ports together in a ring or daisy chained configuration. This optional ring interconnection of network interfaces may be used when exchanging video or image information, as with a video-conference application of the communication system. Of course, network interfaces can also be connected in a star configuration or other configurations as required.

There are at least three mechanisms through which software switched transmission or software switched logical connections can be established under software control. First, a user could interact with a GUI interface on a personal computer running a software application and connected to some interface of a communication system. In a second option, automatic software modules can operate real-time in order to effect software switched transmissions of data, to establish and de-establish logical connections of network interfaces, or both. Third, status events or other events occurring at one or more network interfaces can be monitored by software, such that software switched transmissions or software switched logical connections between network interfaces can be setup under event driven software control.

Software switched transmission may also comprise transmitting data directly between network interfaces through the PCI bus, independently of the processor, after the software switched logical connection is established between network interfaces. The network interfaces can use the logical connection or hardware path once established to transfer data between network interfaces. After the logical connection has been established under software control, data transfers may be started by and carried out autonomously between network interfaces, without further software or processor intervention. For example, DMA transfers between network interfaces can occur automatically sometime after software has established a logical connection between interfaces by enabling DMA transfers between those two interfaces. Data transfers through a logical connection can continue uninterrupted—until and unless there is no more data to transfer or the logical connection between network interfaces is disabled or de-established under software control.

Software is used to customize the data link layer, one or more higher network layers, or both, associated with a network format supported at a network interface. This customization can occur at discrete times on demand or dynamically to modify the function of a network interface, such as by modifying the software executed by a processing resource or the parameters processed by a processing resource. Various protocol stacks can be supported by customizing the software or parameters used by the processing resource supporting the network interface.

The received data or information can be transmitted directly between the one network interface and the other network interface through the software switched logical connection between network interfaces. Direct transfers between network interfaces could optionally include intervening hardware devices, such as switches, routers, or the like, between network interfaces. The logical connection or path between network interfaces could be established by processor interaction with the intervening hardware devices. However, these direct transfers could be optionally provided herein such that there are no intervening hardware switching or routing devices between network interfaces. In any case, after the processor executing software has established the logical connection, the transmission of data through the software switched logical connection can occur without further processor intervention.

The software program executed by the external processor of the external node could include a software module or software application for interacting with the communication system, interfaces could include network interfaces, external interfaces, or both of a communication system. In addition, the external processor could optionally determine what bandwidth, what type of network, what network format, what format of data, and what type of information are associated with each interface of the communication system. An event or activity could represent some communication between the communication system and an attached network or device, or could represent detecting some link or network going online or offline. The software program can analyze the event or activity occurring at the communication system, and may or may not transmit a control message or the like to the communication system which could cause the communication system to take some action in response. For instance, the software program could cause the communication system to initiate another event or activity for responding to an event or activity occurring at an interface. Optionally, the software program could initiate some event or activity at an interface of the communication system, whether or not in response to another event or activity occurring at the communication system. The software program executed by the external processor could also determine whether to connect interfaces together, which two or more interfaces to connect together, and how to connect interfaces together in a communication system connected either directly or indirectly to the external processor. Optionally, the external processor executing the software program may transmit network interface connection information to a processor in a communication system of the present invention connected thereto.

The communication system has the capability to transfer data bi-directionally, such as by providing full duplex data transfers between network interfaces, through the shared non-switched system bus or through some other connection between interfaces as described.

Software executing in a processor may determine which network interfaces should be enabled to exchange data there between. Once the processor executing software has determined which network interfaces are to exchange data, such as between network interfaces, software issues commands to those network interfaces. Data transfers can be established between any two or more network interfaces, including external interfaces, as may be required. Each network interface can transfer data to and receive data from, one or more other network interfaces in an interleaved bi-directional manner. While bi-directional data transfers can be established, data transfers in one direction between network interfaces are also supported as a subset of the bi-directional transfers that can be enabled. Since data transfers may optionally be performed through the shared non-switched system bus, some interleaved data transfers may at times be queued temporarily waiting to access the shared non-switched system bus.

The processor executing a software program can use the network interface connection information received to optionally establish a software switched logical connection between the first network interface and the second network interface. The processor executing a software program can establish the logical connection automatically and without any real-time intervention from a user of the communication system. The logical connection is software switched since the processor executing a software program determines which network interfaces are to be logically connected together, and establishes the logical connection there between. The software switched logical connection may comprise a hardware connection established under software control by the processor. The hardware connection is established by the processor between the first and second network interfaces for transmitting data between network interfaces. For example, assuming that the network interfaces within the communication are memory mapped, the software switched logical connection could comprise creating a memory mapped connection between network interfaces. Accordingly, the hardware logical connection could be a unidirectional logical connection or bi-directional logical connection established between memory mapped network interfaces for exchanging data.

A multimedia distribution apparatus and method is described above. Various details of the invention may be changed without departing from its scope. Furthermore, the foregoing description of the preferred embodiment of the invention and the best mode of practicing the invention are provided for the purpose of illustration only and not for the purpose of limitation.

What is claimed is:

1. A multimedia apparatus for allowing an individual to upload and download multimedia content to and from a central command center, comprising:
(a) an enclosure for providing a quiet environment, the enclosure including:
(i) an audio recording means for recording audio content;
(ii) a video recording means for recording video content;
(iii) an editing means for editing the recorded audio and video content;
(iv) a storage means for storing edited audio and video content locally; and
(b) a communication means for uploading edited audio and video content to the central command center.

2. The multimedia apparatus according to claim 1, wherein the audio recording means includes a microphone selected from the group consisting of a large diaphragm condenser microphone and a small diaphragm condenser microphone.

3. The multimedia apparatus according to claim 1, wherein the multimedia apparatus further include a means for performing karaoke.

4. The multimedia apparatus according to claim 3, wherein the means for performing karaoke includes a touchscreen with lyrics displayed thereon.

5. The multimedia apparatus according to claim 3, wherein the means for performing karaoke further includes a green screen for selecting a background.

6. The multimedia apparatus according to claim 1, wherein the communication means is selected from the group consisting of hard-wired transmission systems and wireless transmission systems.

7. The multimedia apparatus according to claim 1, and further including a touch screen and graphical user interface for inputting commands to the multimedia apparatus and allowing an individual to browse and search a catalogue of recorded content to sample, select, download, burn, and purchase the recorded content using direct point of sale communications.

8. The multimedia apparatus according to claim 1, wherein the enclosure further includes a monitor for video playback of the video content and at least one speaker for audio playback of the audio content.

9. The multimedia apparatus according to claim 1, wherein the enclosure further includes at least one media reader for uploading previously recorded content to the multimedia apparatus.

10. The multimedia apparatus according to claim 1, wherein the enclosure further includes at least one writing device for downloading and writing the audio and video content to digital media.

11. A multimedia distribution network, comprising:
(a) a central command center for receiving, storing, and distributing audio and video content;
(b) at least one multimedia apparatus remote from the central command center for allowing an individual to upload and download audio and video content to and from the central command center, comprising:
(i) an enclosure for providing a quiet environment, the enclosure including means for recording audio and video content, an editing means for editing the audio and video content, and a storage means for storing the audio and video content locally; and
(c) a communications system interconnecting the at least one multimedia apparatus and the central command center, so as to allow the multimedia apparatus to upload audio and video content to the central command center and download audio and video content from the central command center.

12. The multimedia distribution network according to claim 11, wherein the means for recording audio content includes a microphone selected from the group consisting of a large diaphragm condenser microphone and a small diaphragm condenser microphone.

13. The multimedia distribution network according to claim 11, wherein the means for recording video content includes a video camera.

14. The multimedia distribution network according to claim 11, wherein the editing means is selected from the group consisting of multi-track wave editors, sequencers, and mixers.

15. The multimedia distribution network according to claim 11, wherein the storage means includes a computer.

16. The multimedia distribution network according to claim 11, wherein the central command center includes a server, a router, and a switch for blanket transmitting the audio and video content to the at least one multimedia apparatus, personal computers, cellular phones, and kiosks.

17. The multimedia distribution network according to claim 11, wherein the audio and video content include music, poetry, comedy, independent films, audio books, ringtones, and wallpaper.

18. The multimedia distribution network according to claim 11, wherein the communications system includes networks selected from the group consisting of high-speed telephony, fiber-optic, cable, internet protocol, internet, intranet, multicast, and peer to peer.

19. The multimedia distribution network according to claim 11, wherein the communications system includes a first network interface and a second network interface interconnected by a shared non-switched system bus for allowing the communications system to interface with multiple networks and protocols.

20. A method for uploading and distributing recorded content, comprising the steps of:
(a) providing a multimedia apparatus including an enclosure and a communication means, the enclosure including an uploading means, an editing means, and a storage device;
(b) uploading and saving the recorded content to the multimedia apparatus using the uploading means;
(c) editing the recorded content using the editing means;
(d) saving an edited version of the recorded content to the storage device;
(e) uploading the edited version through the communication means to a command center for distribution.

21. The method according to claim 20, wherein the uploading means is a media reader for allowing previously recorded content to be uploaded to the multimedia apparatus.

22. The method according to claim 21, wherein the step of uploading and saving the recorded content includes the step of placing previously recorded content into the media reader and saving the recorded content to the storage device.

23. The method according to claim 20, wherein the uploading means is a microphone for allowing spontaneously performed recorded content to be uploaded to the multimedia apparatus.

24. The method according to claim 24, wherein the step of uploading and saving the recorded content includes the step of activating the microphone so as to allow the recorded content to be saved to the storage device.

25. The method according to claim 20, wherein the uploading means is a video camera for allowing spontaneously performed recorded content to be uploaded to the multimedia apparatus.

26. The method according to claim 25, wherein the step of uploading and saving the recorded content includes the step of activating the video camera so as to allow the recorded content to be saved to the storage device.

27. The method according to claim 20, wherein the editing means is selected from the group consisting of multi-track wave editors, sequencers, and mixers.

28. The method according to claim 20, wherein the communication means is selected from the group consisting of hard-wired transmission systems and wireless transmission systems.

29. The method according to claim 20, and further including the step of reviewing the edited version.
